(19) United States
(12) Patent Application Publication
(10) Pub. No.: US 2026/0322770 A1
(43) Pub. Date: Oct. 15, 2026

(54) METHOD AND DEVICE FOR PREPARING DATA FOR TRANSMISSION IN OPTICAL NETWORK

(71) Applicant: Oriole Networks Ltd., London (GB)

(72) Inventors: George Zervas, London (GB); Vaibhawa Mishra, London (GB); Joshua Benjamin, London (GB)

(73) Assignee: Oriole Networks Ltd., London (GB)

(21) Appl. No.: 19/647,705

(22) Filed: Apr. 14, 2026

(30) Foreign Application Priority Data
Apr. 15, 2025 (EP) 25300043.4

(51) Int. Cl. H04L 49/90; H04B 10/27

(52) U.S. Cl. CPC H04L 49/90; H04B 10/27

(57) ABSTRACT

A method of preparing data for transmission in a network, the method comprising: receiving a plurality of data packets from a data source, each data packet comprising payload data to be transmitted over the network and header data comprising data representing a destination to which the payload data is to be delivered; dividing the payload data of the data packets into a plurality of data chunks, wherein each data chunk is configured to be transmitted over the network in a respective time slot to be assigned to the data chunk; generating requests for grant of time slots for transmitting the data chunks over the network to network destinations in the network corresponding to the destinations represented in the header data of the data packets; transmitting the requests for grant of time slots to a data scheduling unit, DSU; receiving time slot grants from the DSU, the time slot grants defining time slots in which data chunks are permitted to be transmitted to network destinations specified by the time slot grants; writing the data chunks to a buffer memory; assigning, to each of the data chunks written to the buffer memory, a respective buffer token and recording a mapping between each buffer token and the memory address of the respective data chunk in the buffer memory; reading, using the buffer tokens, the data chunks from the buffer memory for transmission over the network in accordance with the received time slot grants

### CROSS-REFERENCE TO RELATED APPLICATIONS

This application claims the benefit of priority under 35 U.S.C. 119 to European Patent Application No. 25300043.4, filed Apr. 15, 2025, the entire disclosure of which is incorporated by reference herein in its entirety and for all purposes.

### FIELD OF THE INVENTION

The present disclosure relates to methods and devices for preparing data for transmission in an optical network.

### BACKGROUND

High-speed, high-bandwidth and long-distance data transmission is in demand across a variety of modern industries. For example, data centres for applications such as cloud computing and hosting artificial intelligence (AI) are required to process extremely large volumes of data with low latency. Modern telecommunications networks are also required to handle high volumes of traffic being transmitted over large distances. For applications such as these, optical networks are frequently employed and are favoured for their ability to achieve low latency, high bandwidth, high energy efficiency and low transmission losses.

In an optical network, data is encoded in light signals transmitted through a refractive medium such as glass fibres. To prepare data for transmission over the optical network, the optical network employs a network interface card (NIC), which is a component configured to receive the data to be transmitted from a data source (e.g. a server in the network) and control transceivers to generate light signals in which the data to be transmitted is encoded. The data being transmitted over the optical network must pass through the NIC, so the bandwidth of data transmission over the network is limited by the bandwidth of the NIC itself.

Modern communications and data processing applications such as AI models are demanding increasingly greater networking and computing capacity. There is hence a need for optical networks of greater bandwidth than are currently available.

### SUMMARY

A first aspect of the present disclosure provides a method of preparing data for transmission in a network, the method comprising:
receiving a plurality of data packets from a data source, each data packet comprising payload data to be transmitted over the network and header data comprising data representing a destination to which the payload data is to be delivered;
dividing the payload data of the data packets into a plurality of data chunks, wherein each data chunk is configured to be transmitted over the network in a respective time slot to be assigned to the data chunk;
generating requests for grant of time slots for transmitting the data chunks over the network to network destinations in the network corresponding to the destinations represented in the header data of the data packets;
transmitting the requests for grant of time slots to a data scheduling unit, DSU;
receiving time slot grants from the DSU, the time slot grants defining time slots in which data chunks are permitted to be transmitted to network destinations specified by the time slot grants;
writing the data chunks to a buffer memory;
assigning, to each of the data chunks written to the buffer memory, a respective buffer token and recording a mapping between each buffer token and the memory address of the respective data chunk in the buffer memory;
reading, using the buffer tokens, the data chunks from the buffer memory for transmission over the network in accordance with the received time slot grants.

Typically, the network is an optical network, though it will be appreciated that the method is applicable to other kinds of network (e.g. those in which signals are transmitted using electrical signals). The manner in which the data chunks are buffered in this method provides a faster and more flexible manner of preparing the payload data for transmission over the network than conventional techniques. In the method above, the data chunks are stored in a buffer memory and the memory addresses in which the data chunks are stored in the buffer memory are indexed against buffer tokens assigned to the data chunks. This is in contrast to conventional approaches to data transmission in optical networks, which take a streaming-type approach where data is processed in a first-in-first-out manner. Storing the data chunks in a buffer memory with the manner of indexing described above allows data chunks to be transmitted in a sequence different to the order in which the payload data to be transmitted was received, allowing increased flexibility over the sequence in which the data chunks are transmitted and therefore making the data transmission less prone to delay when certain items of data are not able to be transmitted at a certain time (e.g. because no resources are available for receiving the data at its destination). Thus, the method defined above provides a more flexible approach to preparing data for transmission over the network which reduces delays and ultimately improves the rate of data transmission in networks such as optical networks.

Typically, the steps of the method are performed by a network interface module (such as a network interface card) that is comprised by a node of the network (e.g. optical network). The data source may be a source external to the network interface module (such as a server comprised by the node) or in some implementations may be a part of the network interface module itself, for example a performance monitoring component. The data packets are typically received from the data source over an electronic data connection, e.g. a PCIe connection between the network interface module and a server comprised by the node.

The time slots are typically each of the same duration, e.g. 100 nanoseconds (ns) each. As will be discussed below, the entity or system (e.g. network interface module) implementing the method may keep time such that time is divided into time slots and epochs, with each epoch comprising a predetermined number of time slots (e.g. 10 time slots per epoch). This time keeping scheme may be followed by all elements (e.g. nodes) of the network, such that each element of the network is aware of the current epoch and time slot. The entity performing the method, e.g. a network interface module, may comprise or be in communication with a slot timer component that keeps track of the current epoch and time slot.

As noted above, the data chunks are obtaining by dividing the payload data of data packets into the data chunks. Thus, each data chunk is a portion of the payload data of one of the data packets. The data chunks may alternatively be referred to as “data fragments” or “data portions”. Each data chunk (or data portion) comprises a quantity of data no greater than can be transmitted within one of the granted time slots.

The buffer memory defined above in the first aspect may be referred to as a “transmit buffer memory” to distinguish it from other buffers and memories that may be present in some embodiments.

In preferred implementations, the method further comprises looking up the destinations of the payload data of each of the data packets in a destination table that comprises mappings of the destinations of the payload data of the data packets to network destinations in the network, and tagging each data chunk with a network destination identifier which identifies the network destination mapped in the network destination table to the destination of the payload data of the data packet from which the data chunk was generated; wherein preferably the data representing the destination of the payload data in each data packet is a network address. For example, the network address could be a network address of a conventional format (e.g. a MAC address) of a destination in the network, for example a node of the network, to which the payload data is intended to be transmitted. The network destination identifier, for example a node ID, of the network destination (which may be referred to as a “destination node ID”) would then be identified by looking up the network address in the destination table. The destination table could be structured such that it contains a first column storing the network addresses and a second column storing the network destination identifiers (e.g. node IDs), such that the node ID associated with a particular network address can be looked up by querying the destination table for the row containing that network address. The destination table may be configured to receive the mapping of network addresses to network destinations from a server external to the network interface module. Typically, the network is an optical network and the network destinations are nodes in the optical network. In an optical network, the node ID may identify a particular server within a rack of servers, which may itself belongs to a cluster of racks. “Tagging” the data chunk as described above may comprise generating header data comprising the data with which the data chunk is tagged and may further comprise storing said data. (It should be appreciated that the data with which the data chunk is tagged does not necessarily become part of the data content of the data chunk-for example, in an embodiment that will be discussed below, the data chunks are tagged with the network destination identifier and a timestamp identifying a time at which the data chunk was generated from its respective data packet, and this data is stored in a request and grant table. This data can then be used in later steps of the method to identify the data chunk when a time slot grant for its transmission has been received.)

In preferred embodiments, each of the data chunks is further tagged with an importance level value, wherein preferably the requests for grant of time slots comprise the importance level values of the data chunks for which time slot grants are being requested. There may be two or more importance level values. A higher importance level value signifies that the data chunk is of higher importance and may signal to the DSU and/or the entity, e.g. a NIC, performing the method that processing of the data chunk should be prioritised relative to data chunks with lower importance level values. For example, the DSU may prioritise issuing time slot grants for data chunks with higher importance level values. The steps of generating requests for grant of time slots and/or transmitting the requests for grant of time slots may be performed such that requests for grant of time slots are generated and/or transmitted in an order determined by the importance levels of the data chunks, such that requests are generated and/or transmitted earlier for the data chunks with higher importance level values. The step of reading the data chunks from the buffer memory may also be performed such that the data chunks are read from the buffer memory in an order determined by their importance level values, such that data chunks with higher importance levels are read from the buffer memory earlier than those with lower importance level values.

Advantageously, the method may further comprise receiving one or more back-pressure signals and, in response to receiving the one or more back-pressure signals, performing one or more control logic functions, wherein preferably the one or more control logic functions comprise one or more of: limiting a rate at which the payload data of the data packets are data packets are divided into data chunks, limiting a rate at which the requests for grant of time slots are transmitted to the DSU, and merging the payload data of at least some of the data packets before dividing those data packets into data chunks. By limiting the rate at which data is prepared for transmission (e.g. by limiting the rate at which the data chunks are generated from data packets, thereby reducing the rate at which new data chunks are placed into the buffer memory, limiting the rate at which requests for grant of time slots are transmitted to the DSU, or merging data packets), a situation can be avoided in which a bottleneck at one stage (e.g. the DSU) causes problems upstream, such as the buffer memory becoming full.

In preferred embodiments, the method further comprises: monitoring the age of each of the data chunks stored in the buffer memory; determining that the ages of one or more of the data chunks stored in the buffer memory have exceeded a predetermined threshold age; and discarding the buffer tokens of those data chunks and/or removing those data chunks from the buffer memory. In this embodiment, data chunks which are over a certain age are removed from the buffer memory. This is advantageous in scenarios such as when a destination node goes offline and no time slot grants can be issued for that destination node, which would otherwise cause data chunks directed to that destination node to remain in the buffer memory indefinitely. In particularly preferred implementations, when a data chunk exceeds the threshold age, the data source (e.g. a host server) is informed and is thus enabled to re-examine the current priority of the corresponding data packet (which may be increased due to the delay in its transmission) and generate fresh data to be transmitted with the new priority level.

Preferably, each of the data chunks is further tagged with a timestamp identifying a time at which the data chunk was generated from said data packet. This timestamp may be referred to as the “birth timestamp” of the data chunk. In particularly preferred implementations, the timestamp comprises the time slot and epoch (in the timing scheme discussed above, where time is divided into epochs that are themselves each divided into a plurality of time slots) in which the data chunk was generated from the data packet.

As will be shown below with reference to examples, tagging the data chunks with their respective network destination identifiers and, preferably, birth timestamps, enables the data chunks to be matched to appropriate time slot grants once the time slot grants have been received.

In preferred implementations, for each data chunk, a respective request for grant of time slots is generated, wherein each request for grant of time slots comprises the network destination identifier and the timestamp with which the data chunk is tagged. This information can be used to identify the data chunks to which the request for grant of time slots relates when time slot grants are received in a later step of the method, as will be shown below. In these embodiments, one request for grant of time slots is generated per data chunk.

The method preferably further comprises storing the generated requests for grant of time slots in a request and grant table. Once time slot grants have been received in response to a particular request for grant of time slots, that request for grant of time slots may be removed from the request and grant table so as to minimise the data storage resources occupied by the request and grant table.

Preferably, each of the received time slot grants comprises data identifying a time interval during which the corresponding request for grant of time slots was generated. When time slot grants are then received in response to the request for grant of time slots, this information can be used to identify the corresponding request for grant of time slots in the request and grant table. For example, in particularly preferred embodiments, reading the data chunks from the buffer memory in accordance with the received time slot grants comprises, for each received time slot grant: looking up, in the request and grant table, a request for grant of time slots comprising the time interval identified by the time slot grant and having the same network destination; and reading from the buffer memory the data chunk for which said request for grant of time slots was generated. It is preferred that each time slot grant comprises the network destination identifier of the request for grant that it was issued in response to (which may have been comprised by the request for grant, as discussed above). The time interval mentioned above (during which the corresponding request for grant of time slots was generated) is preferably the epoch in which the respective data chunk was generated, which, as discussed above, may have been comprised by the request for grant.

Preferably, each buffer token comprises data identifying the network destination of the data packet from which the chunk was generated and a timestamp identifying a time at which the data chunk was generated from said data packet. This information can be used to identify the appropriate data chunk to be retrieved in response to a particular time slot grant. The timestamp is preferably the same timestamp as the timestamp with which the data chunk was tagged as described above, which comprises the epoch and time slot during which the data chunk was generated.

Preferably, assigning each buffer token to its respective data chunk comprises storing the buffer token in a buffer token storage, and wherein the method further comprises removing the buffer token from the buffer token storage after the respective chunk has been read from the buffer memory. Removing the buffer tokens from the buffer token storage makes the associated memory address in the buffer memory free for storage of further data chunks thereafter.

In a preferred embodiment, the method further comprises: storing the data chunks read from the buffer memory in one or more transmit buffers that are in communication with one or more transceivers configured to generate signals (preferably optical signals) for transmitting the data chunks over the network (which is preferably an optical network); and transmitting the data chunks from the transmit buffers to the transceivers for transmission over the network by the transceivers. The transmit buffers have the purpose of holding the data chunks in such a state that they can be quickly sent to the transceivers during the time slots in which they are to be transmitted. In particularly advantageous embodiments, different data chunks destined for the same network destination may be simultaneously stored in different transmit buffers, which improves the bandwidth available for transmission of data to the network destination in question. Preferably, for each transmit buffer, the data chunks stored in the transmit buffer are stored in an order corresponding to the temporal order of the time slots in which those data chunks are to be transmitted. (The “order” in which the data chunks are stored in the transmit buffer here refers to the temporal order in which they were placed into the transmit buffer.) In particularly preferred embodiments, the transmit buffers are first-in-first-out memories, such that the order in which the data chunks are transmitted from each transmit buffer to the transceivers is the same as the order in which the data chunks stored in that transmit buffer were stored in the transmit buffer.

A second aspect of the present disclosure provides a method of receiving data
transmitted over a network, the method comprising:
receiving a plurality of data chunks transmitted over the network;
writing the data chunks to a buffer memory;
assigning, to each of the data chunks written to the buffer memory, a respective buffer token and recording a mapping between each buffer token and the memory address of the respective data chunk in the buffer memory;
reading, using the buffer tokens, the data chunks from the buffer memory; and
assembling the data chunks read from the buffer memory into one or more data packets, each data packet comprising at least one of the data chunks.

Typically, the network is an optical network, though it will be appreciated that the method is applicable to other kinds of network (e.g. those in which signals are transmitted using electrical signals). Similar to the method of the first aspect, the manner in which the data chunks are buffered in this method provides a faster and more flexible manner of receiving data transmitted over the network than conventional techniques. Storing the data chunks in a buffer memory with the manner of indexing described above allows data chunks that were received in a sequence different to that in which they were arranged when they were generated (typically at a source node in the network), allowing increased flexibility over the sequence in which the data chunks are transmitted and received and therefore making the data transmission less prone to delay when certain items of data are not able to be transmitted at a certain time (e.g. because no resources are available for receiving the data at its destination). Thus, the method defined above provides a more flexible approach to receiving data transmitted over the network, which reduces delays and ultimately improves the rate of data transmission in networks such as optical networks.

As will be discussed below, in some embodiments, the method may comprise, for each data packet, computing a sequence in which the data chunks of the data packet are to be assembled before reading the data chunks from the buffer memory. This may take place while some or all of the data chunks are stored in the buffer memory. For example, a sequence position of each data chunk in its respective data packet may determined in response to the data chunk being written to the buffer memory, and the data chunks of the data packet may be read from the buffer memory and assembled into the data packet once the sequence positions of all the data chunks of the data packet have been determined.

Typically, the steps of the method are performed by a network interface module (such as a network interface card) that is comprised by a node of the network (e.g. optical network). The packets assembled from the data chunks will typically be sent to a host destination such as a server comprised by the node or, in some implementations, a part of the network interface module itself, for example a performance monitoring component. The data packets are typically sent to the host destination over an electronic data connection, e.g. a PCIe connection between the network interface module and a host server comprised by the node.

Like in the method of the first aspect, each of the data chunks typically comprises a quantity of data that is no greater than can be transmitted by the network within one time slot. The time slots are typically each of the same duration, e.g. 100 nanoseconds (ns) each. As was discussed above, the entity or system (e.g. network interface module) implementing the method may keep time such that time is divided into time slots and epochs, with each epoch comprising a predetermined number of time slots (e.g. 10 time slots per epoch). This time keeping scheme may be followed by all elements (e.g. nodes) of the network, such that each element of the network is aware of the current epoch and time slot. The entity performing the method, e.g. a network interface module, may comprise or be in communication with a slot timer component that keeps track of the current epoch and time slot.

As noted above, the data chunks typically represent a portion of the payload data of a data packet that was prepared for transmission by a source node in the network. Thus, each data chunk is typically a portion of the payload data of such a data packet. The data chunks may alternatively be referred to as “data fragments” or “data portions”. Each data chunk (or data portion) comprises a quantity of data no greater than can be transmitted within one of the granted time slots.

The buffer memory defined above in the second aspect may be referred to as a “receive buffer memory” to distinguish it from other buffers and memories that may be present in some embodiments.

In particularly preferred implementations, the data chunks received in the method of the second aspect will have been produced by a node (or other entity) in the network performing the method of the first aspect. In this case, the data packets produced in the method of the second aspect will correspond to the payload data of the data packets from which the data chunks were produced in the first aspect. The data packets produced in the second aspect may be referred to as “reassembled data packets” to distinguish them from the data packets referred to in connection with the first aspect.

The method may advantageously further comprise tagging each of the data chunks with a network source identifier which identifies a network source from which the data chunk was received and/or a timestamp identifying a time at which the data chunk was received. The network source is typically a node of the network from which the data chunks were transmitted (which will be referred to as a “source node”). The network source identifier may be a node ID of the source node (a “source node ID”). The timestamp may comprise the epoch and time slot in which the data chunk was received by the entity (e.g. network interface module) performing the method. “Tagging” the data chunk as described above may comprise generating header data comprising the data with which the data chunk is tagged and may further comprise storing said data.

Preferably, each buffer token comprises the network source identifier and/or the timestamp with which the respective data chunk was tagged.

In preferred implementations, assembling the data chunks into the one or more data packets comprises:
defining, for each data packet, a respective reordering window, the reordering window comprising a sequence position for each data chunk belonging to the data packet;
assigning to each of the data chunks one of the sequence positions in the reordering window of the data packet to which the data chunk belongs; and
wherein reading, using the buffer tokens, the data chunks from the buffer memory comprises, for each of the reordering windows, in response to all the sequence positions of one of the reordering windows having been assigned to a respective data chunk, reading the data chunks of the data packet from the buffer memory; and
wherein the step of assembling the data chunks read from the buffer memory into one or more data packets comprises, for each of the data packets, assembling the data chunks of the data packet into the data packet in response to said data chunks being read from the buffer memory.

The use of reordering windows to arrange the data chunks as set out above exploits the buffer memory, which enables the data chunks to be stored temporarily while the order of the data chunks is being determined. Thus, incoming data chunks may continue to be received while the sequence of the data chunks is being determined, and the processing of data chunks received subsequently is not held up while the reassembling of those data chunks already received is in progress. The data packet to which each data chunk belongs, and its sequence position within the data packet, may be determined from metadata comprised by the data chunk. For example, the data chunk may comprise metadata that includes a packet ID (identifying the data packet to which the data chunk belongs), a chunk ID (which may be, for example, a serial number from which the sequence position of the data chunk relative to other data chunks in the data packet may be inferred) and a flow ID (which represents, for example, a specific flow of data from a source to a destination, such as a flow of data associated with a specific application).

The method preferably further comprises: looking up the network source identifier of each of the data packets in a source table that comprises mappings of the network source identifiers to host destinations; and transmitting each of the data packets to the host destination to which the source identifier of the data packet is mapped in the source table. As noted above, examples of host destinations to which the assembled data packets may be transmitted include a host server comprised by a node that also comprises the network interface module that receives the data packets.

A third aspect of the present disclosure provides a network interface module configured to perform the method of the first aspect and/or the method of the second aspect. It is indeed preferred that the network interface module is configured to perform both methods, since such a network interface module is suitable for controlling both transmission of data from, and receiving of data transmitted to, a network node in which it is comprised. In a network comprising a plurality of nodes each comprising such a network interface module, the nodes may transmit data to, and receive data from, one another using the methods of the first and second aspects of the present disclosure.

The network interface module may be configured to perform any of the optional features of the methods described above. The network interface module may be a network interface card (NIC). As discussed above with reference to the first aspect, the network interface module may may comprise or be in communication with a slot timer component that keeps track of the current epoch and time slot. The same slot timer may be used in implementing the methods of both the first aspect and the second aspect.

The network interface module may further comprise the buffer memory. (In the case of a network interface module configured to perform the methods of both the first and second aspects, a single buffer memory may be used to implement both methods, or separate buffer memories may be provided.) However, in other embodiments, the buffer memory is not part of the network interface module and the network interface module communicates with the buffer memory when performing the method.

Preferably, the network interface module comprises a field programmable gate array configured to perform the method. As will be discussed below with reference to an example, a field programmable gate array (FPGA) is an integrated circuit that can be reprogrammed to implement a desired set of tasks. An FPGA provides a convenient manner of implementing the set of functions required to perform the method defined above.

The present disclosure also provides a computer-readable medium comprising instructions which, when executed by a process, cause the processor to perform the method of the first aspect of the present disclosure and/or the method of the second aspect of the present disclosure.

The present disclosure also provides a computer-readable medium comprising instructions which, when executed by a processor in communication with an FPGA, cause the processor to program the FPGA to perform the method of the first aspect of the present disclosure and/or the method of the second aspect of the present disclosure.

### BRIEF DESCRIPTION OF THE DRAWINGS

Examples of methods and apparatus in accordance with embodiments of the present disclosure will now be described with reference to the accompanying drawings, in which:

FIG. 1 shows schematically an example of a simple optical network;

FIG. 2 shows an example of a node of an optical network;

FIG. 3 shows an example of a network interface module suitable for use in nodes of optical networks;

FIG. 4 shows an example of an optical network comprising a plurality of nodes of the kind shown in FIG. 2;

FIG. 5 illustrates a timing scheme that is employed by an network interface module in an embodiment of the present disclosure;

FIG. 6 shows an example of a field programmable gate array of a network interface module in accordance with an embodiment of the present disclosure;

FIG. 7 shows an example of payload data being divided into data chunks corresponding to time slots as part of an embodiment of the present disclosure;

FIG. 8 is a flow diagram illustrating a method in accordance with an embodiment of the present disclosure;

FIG. 9 shows an example of requests for grant of time slots stored in the request and grant table of FIG. 6;

FIG. 10 shows an example of time slot grants stored in the request and grant table of FIG. 6;

FIG. 11 shows an example of a buffer token table stored by the buffer token component of FIG. 6;

FIG. 12 shows an example of a field programmable gate array of a network interface module in accordance with an embodiment of the present disclosure;

FIGS. 13-20 show implementations of the field programmable gate array of FIG. 6 including features according to particularly preferred embodiments.

### DETAILED DESCRIPTION

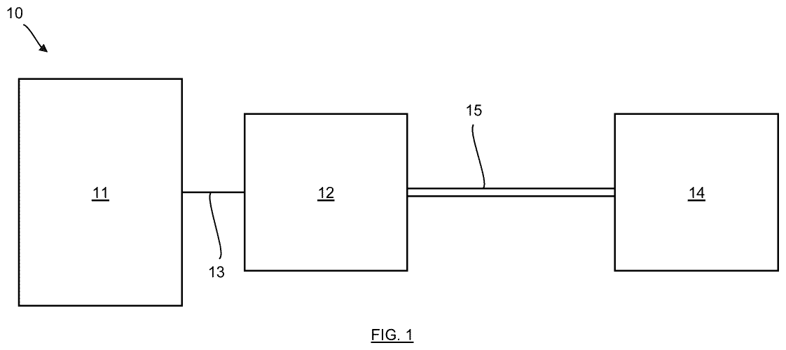

FIG. 1 shows schematically an example of a simple optical network 10. In the optical network 10, a first node 12 is in communication with a server 11 via a data connection 13, which is typically an electronic connection such as a PCIe connection. The first node 12 is in communication with a second node 14 via an optical connection 15, which is typically implemented by one or more optical fibres. The first node 12 is configured to receive data packets from the server 11 via the data connection 13 and transmit the data packets to the second node 14 via the optical connection 15.

Each of the first node 12 and the second node comprises optoelectronic components configured to transmit and/or receive optical signals exchanged over the optical connection 15. To transmit data to the second node 14, the first node 12 controls its optoelectronic components to produce optical signals in which the data is encoded, which are transmitted to the second node 14 through the medium (e.g. optical fibre) that implements the optical connection 15. The optical signal is then received by the optoelectronic components of the second node 14, which convert the optical signal to an electronic signal that can then be processed by the second node 14.

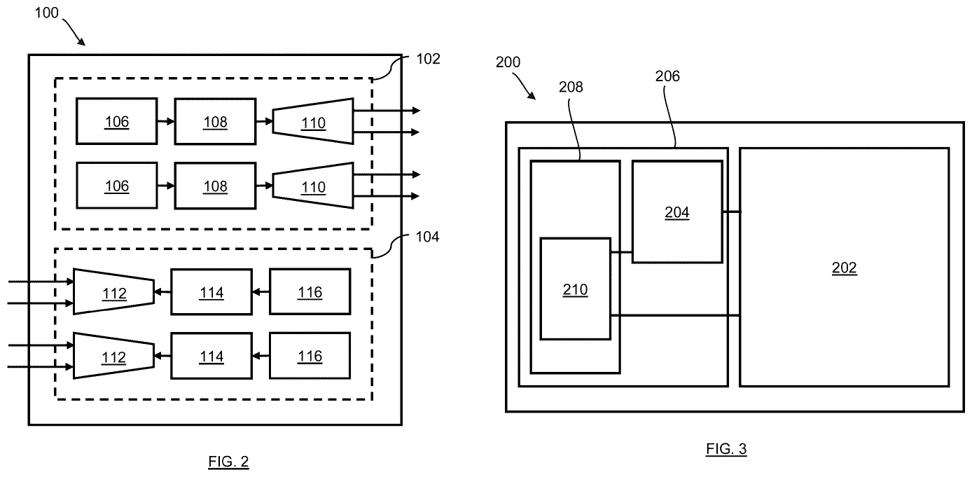

FIG. 2 schematically illustrates a node 100 of an optical network (such as the first node 12 or the second node 14 described above with reference to FIG. 1). The node 100 is a physical or logical entity in the optical network at which data (in the form of light signals) can be processed, redirected, or terminated. For example, a node 100 could be associated with a data centre.

The node 100 has a transmit portion 102 and a receiver portion 104. The transmit portion 102 comprises one or more (Y) independent transmit datapaths to support the connection of Y connection groups. Each transmit datapath is substantially similar, and they typically only differ by the connection group to which they can communicate, as will be discussed further below. Each transmit datapath in a node 12 comprises a wavelength-tuneable laser 106, a modulator 108, and an optical switch component 110. The laser 106 is typically a semiconductor laser 106 that can be tuned to very specific wavelengths (e.g., to a granularity of 36.8 nm) and preferably has a wavelength tuning time of less than 100 ns. The modulator 108 is configured to encode data onto light generated by the laser 106 to generate encoded light. The modulator 108 could be a 56 Gbaud PAM4 optical modulator 108 configured to adjust the amplitude of light output by the laser 106 to encode a symbol. The optical switch 110 is configured to receive the modulated light output by the modulator 108 and “steer” the modulated light such that it is output at one of the X output ports. Each output port is typically connected to another component, such as an output optical fibre or other optical medium configured to transmit optical signals to other nodes or other destinations in the optical network (not shown). While FIG. 1 illustrates two output ports per optical switch 110, it will be appreciated that the node may have more or fewer output ports. The number (X) of output ports per optical switch 110 could be, for example, 8. Additionally, while FIG. 1 illustrates two optical switches 110, this number is not limiting. The number (Y) of optical switches 110 could be, for example, four.

The receiver portion 104 comprises one or more (Y) independent receive datapaths to support the connection of Y connection groups. Each receive datapath is substantially similar, and they typically only differ by the communication group to which they communicate, as will be discussed further below. The receive datapaths are independent of the transmit datapaths and are configured to communicate with a transmit datapath of a different node in the optical network. Each receive datapath comprises an optical switch component 112, a filter component 114, and a photodetection device 116. The optical switch component 112 comprises X input ports and one output port. Each input port of the input switch 112 is configured to receive a respective optical signal, and the input switch 112 is configured to aggregate the optical signals into a single optical signal. The filter component 114 is configured to receive the optical signal output by the input switch 112 and isolate a desired wavelength or set of wavelengths. The photodetection device 116, such as a photodiode 116, is configured to receive the optical signal output by the filter component 114, and generates an electrical signal based on various properties of the received optical signal.

The optoelectronic components of the transmit portion 102 and the receiver portion 104 of the FIG. 2 node (i.e. the lasers 106, modulators 108, switches 110, 112, filter components 114 and photodiodes 116) are typically implemented as part of a network interface module such as a network interface card (NIC). An example of a NIC 200 is illustrated schematically in FIG. 3.

The NIC 200 comprises a photonic integrated circuit (PIC) 210, which comprises the optoelectronic components of the transmit portion 102 and the receiver portion 104 the FIG. 2 node. The PIC is comprised by an optical engine 208, which is a high-speed circuit board that is configured to accommodate the PIC 210 together with other amplifier and driver devices.

The NIC also comprises a field programmable gate array (FPGA) 202, a controller 204, a pluggable module 206, and an optical engine 208. The controller 204 is configured to provide control instructions to the PIC 210. In particular, the controller 204 controls the optoelectronic components including controlling the wavelengths of the lasers 106, the modulators 108, the states of the switches 110, 112 and the filters 114 such that the node 100 transmits and receives optical signals in accordance with a schedule provided by a data scheduling unit, which will be described later. The optical engine 208 and controller 204 are comprised by a pluggable module 206, which can be inserted into and removed from the NIC 200 to facilitate easy installation and replacement.

A field programmable gate array (FPGA) is an integrated circuit that can be reprogrammed to implement a desired set of tasks. In the NIC 200, the FPGA 202 is configured to prepare data for transmission over the optical network by the transmit portion 102 of the node 100. At a high level, the FPGA is configured to receive data packets containing the data to be transmitted from a source such as a server, put the data to be transmitted into a format suitable for transmission in accordance with the timing scheme that is used to schedule data transmission in the optical network, and send the data to the transmit portion 102 at the required times. Before describing the configuration of the FPGA 202 in detail, the manner in which the optical network schedules data transmission will now be described.

While the NIC 200 implements the transmit and receiver portions of the node 100, the node 100 may comprise or be in communication with other components besides the NIC such as data storage and processing components (e.g. servers such as the server 11 shown in FIG. 1) in communication with the NIC 200.

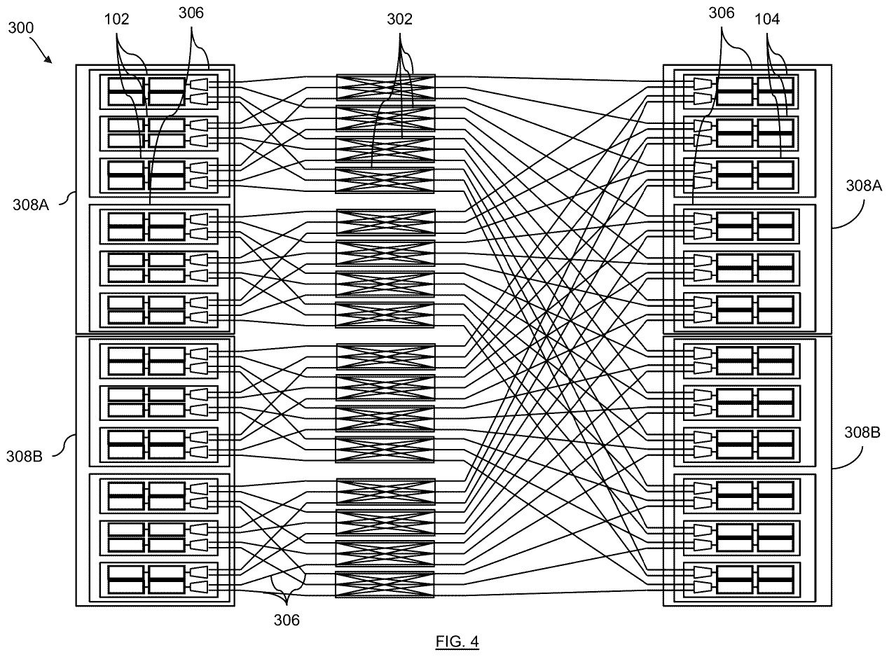

FIG. 4 shows an example of an optical network 300 that facilitates communications between a plurality of nodes 100 of the kind illustrated in FIG. 2. For simplicity, the nodes 100 are shown as being split so that the transmit portions 102 are illustrated on the left-hand side while the receiver portions 104 are illustrated on the right-hand side. As discussed above, each transmit portion 102 comprises a plurality of independent transmit datapaths, each comprising a laser 106, modulator 108, and switch 110. Encoded light from the transmit portion 102 is routed to the appropriate destination (receiver portion 104), based on the wavelength of the encoded light, using an arrayed waveguide router (AWGR) 302. The AWGR 302 is in communication with the transmit portions 102 and receiver portions 104 via optical fibres 304.

The nodes 100 are arranged into a plurality of racks 306, each rack comprising a number of nodes 100 equal to the number of wavelengths Λ supported by the AWGRs 302. For example, the number of wavelengths Λ supported by the AWGRs 302 could be in the range of 2 to 64 wavelengths. In the illustrated example, the number of wavelengths Λ supported by each AWGR 302 is 3 and the number of nodes in each rack 306 is therefore 3. Each node 100 in a rack 306 is assigned a respective wavelength. In this way, encoded light from a source node in a rack 306 to a destination node in the rack 306 can be achieved by using the wavelength assigned to the destination node.

Since each node 100 comprises at least one optical switch 110, the encoded light can be steered to one of X output ports, each being associated with a respective AWGR 302. This provides scalability beyond a single rack 306, because each AWGR 302 is associated with a different rack 306. For example, as shown in FIG. 3A, the upmost transmit portion 104 comprises an upper optical switch having two output ports. The upper output port is connected to an AWGR 302 that provides communication with the upper rack 306, while the lower output port is connected to an AWGR 302 that provides communication with the lower rack 306. The number of racks 306 that can be reached by a single optical switch 110 is equal to the number of output ports (X). To facilitate communication with these additional racks, X² AWGRs 302 are required.

To further scale the network 300, each node 100 comprises a plurality of (Y) transmit and receive datapaths. As discussed above, each transmit datapath of a transmit portion 102 of a node 100 comprises a laser 106, a modulator 108, and an optical switch 110. Each transmit datapath provides communication to a separate communication group 308, each communication group 308 comprising a plurality of racks 306. In the illustrated network 300, each node 100 comprises Y=2 datapaths, so that the network 300 comprises a first communication group 308A and a second communication group 308B. To communicate with the second communication group 308B, a transmit portion 102 of a node 100 of the first communication group 308A utilises a transmit datapath depicted as the lower transmit datapath. To facilitate communication between multiple communication groups 308, (XY)² AWGRs 302 are required, and 2Λ(XY)² optical fibres are required.

The number of nodes 100 supported by a network similar to the network 300 is ΛXY, because Y communication groups 308 can be supported, each communication group 308 having X racks 306, and each rack 306 having Λ nodes. As discussed above, the number of wavelengths Λ supported by each AWGR 302 can be up to 64 wavelengths, the number of racks X can up to 8, and the number of communication groups Y can be up to 4. Therefore, a maximum number of nodes in such a network can be up to 2048 nodes. Each transmit portion 102 of each node 100 of such a network 300 is in direct communication with each receiver portion 104 of each other node in the network 300. That is, each node 100 only requires passive optical components (e.g. AWGRs 302 and optical fibres 304) to communicate with other nodes 100.

In typical applications, many data packets are being exchanged over the optical network 300 at any given time. The optical network 300 employs a data scheduler, or “data scheduling unit” (DSU), to manage the transmission of data such that each node 100 never receives data from more than one other node 100 at the same time. The DSU is in communication with the nodes 100 and receives information from the nodes about the data that the node wishes to transmit. Based on this information, the DSU grants time slots to each of the nodes 100 for the transmission of chunks of data to specific other nodes 100.

The DSU is typically in communication with each of the nodes in the optical network 100 and may communicate with the nodes 100 via optical connections or alternatively by electronic (e.g. wired) connections. The sequence of data transmission dictated by the DSU typically constitutes a form of time division multiplexing (TDM), i.e. a manner of transmission in which multiple signals are simultaneously transmitted by alternately sending chunks of the different signals in an interleaved fashion. In some implementations, the DSU may be a node in the optical network. In this case, each network interface module (e.g. NIC 200) would be preconfigured with one time slot each epoch for NIC/DSU communication. This manner of communication with and DSU may be described as “in-band”. Several NICs may share the same time slot for this purpose. Alternatively, a dedicated optical path separate to those employed for transmission of payload data could be provided for communications with the DSU. This additional optical path would comprise its own laser, modulator, fibre, photodiode and other relevant components. This configuration, which may be described as “out-of-band”, allows communications with the DSU to take place concurrently with transmission of payload data without affecting the bandwidth available for the transmission of the payload data.

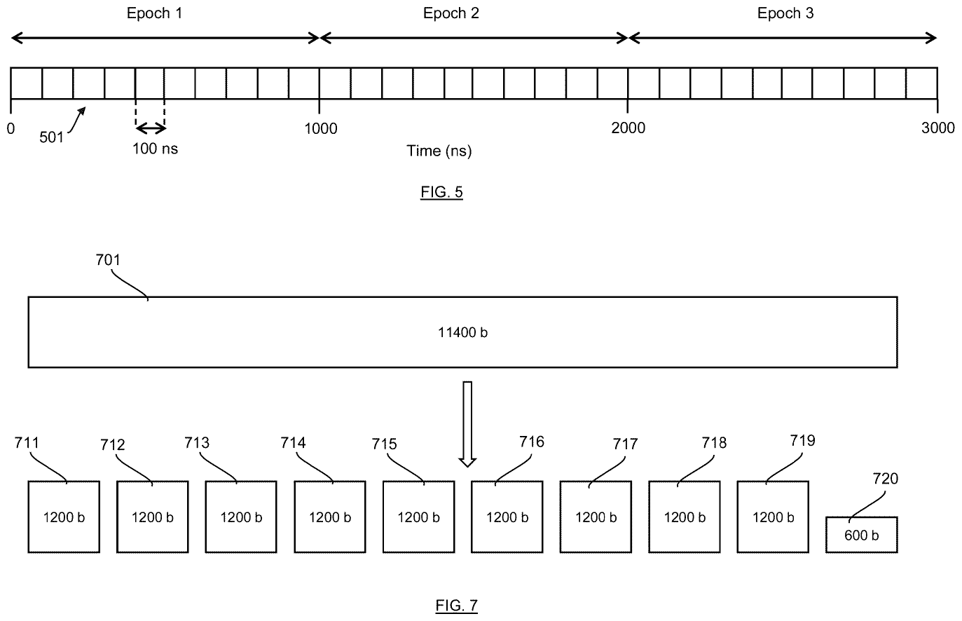

To enable the scheduling of data transmission and the coordination of the nodes 100, the optical network 300 employs a timing scheme in which time is divided into “epochs” each containing a fixed number T of “time slots” (sometimes referred to hereinafter as “slots”). In this example, the number T of slots in each epoch will be set as T=10. Each slot has a fixed duration, which in this example will be set as 100 nanoseconds (ns). The quantity of data that can be transmitted within a single slot is determined by the duration of the slots and the rate of data transfer achievable by the hardware of the optical network. In a typical configuration capable of 100 gigabits per second (Gbps) data transfer, a 100 ns slot corresponds to about 1200 bytes of data. FIG. 5 illustrates three epochs (Epoch 1, Epoch 2, Epoch 3) each comprising 10 slots 501 of 100 ns each.

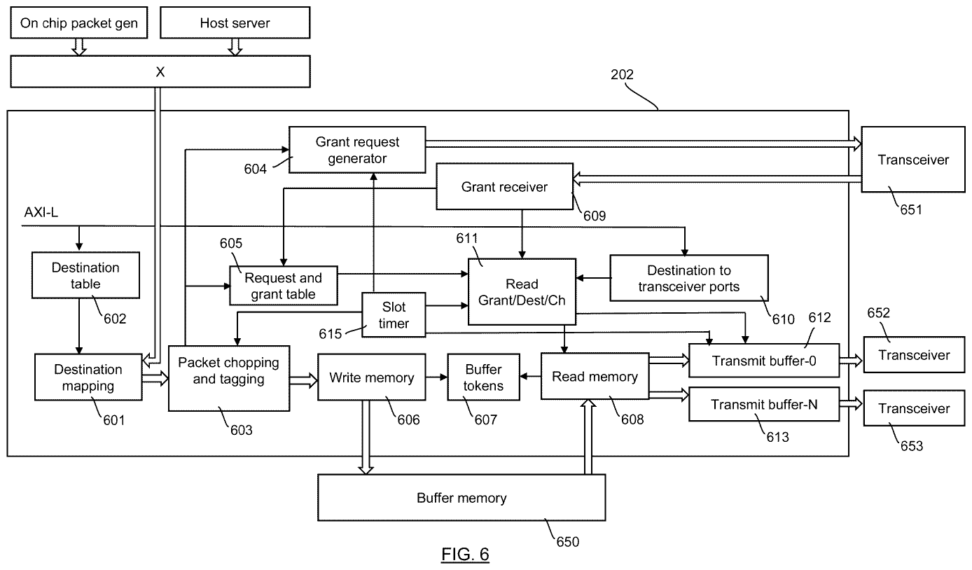

FIG. 6 schematically illustrates the FPGA 202 of the NIC 200. The FPGA 202 is configured to implement a method of preparing data for transmission in a network in accordance with an embodiment of the first aspect of the present disclosure. It will be understood that, while FIG. 6 shows the FPGA 202 as comprising various components (e.g. a destination mapping component 601 and a destination table 602), these components do not necessarily represent distinct physical entities in the FPGA. Rather, FIG. 6 is a schematic representation that illustrates the various processes that the FPGA 202 in this embodiment is configured to perform. The term “component” in this context may thus signify a part of the programming of the FPGA 202 rather than a distinct physical element.

The FPGA is in communication with a plurality of transceivers 651, 652, 653 and a buffer memory 650, the function of which will be discussed below. The transceivers 651, 652, 653 are configured to receive data chunks from the FPGA 202 and transmit the data chunks over the optical network. The transceiver 651 is used to communicate with the DSU for the purposes of sending requests for grant of time slots and receiving time slot grants. The transceivers 652, 653 are used to control the modulators 108 of the transmit portion 102 of the NIC 200 to encode data chunks produced by the FPGA 202 in light generated by the lasers 106. Typically, the DSU is implemented by a node in the optical network and communications between the NIC 200 and the DSU are optical communications eSpexchanged over the optical network. (In this case, specific epochs and/or slots may be reserved for requesting and receiving grants of slots.) In this scenario, the transceiver 651 used to communicate with the DSU may be one of the transceivers 652, 653 used to transmit data over the optical network. For the purposes of illustration, however, FIG. 6 illustrates communications with the DSU being facilitated by a distinct transceiver 651.

The transceivers 651, 652, 653 and the buffer memory may be comprised by the node of the optical network in which the NIC 200 is incorporated. For the avoidance of doubt, in this embodiment, the components shown inside the box labelled 202 in FIG. 6 are implemented by the FPGA 202 of the NIC 200 (e.g. the designation mapping component 201 and the destination table 202) whereas the components outside of the box labelled 200 are not part of the NIC 200 (e.g. the transceivers 651, 652, 653).

The FPGA 202 receives data packets, which are to be transmitted over the optical network from the node in which the NIC 200 is incorporated, from a source such as a host server (e.g. the server 11 shown in FIG. 1) or from a source within the NIC 200 (e.g. control data or performance data), represented by the “on chip packet gen” box shown in FIG. 6. The data packets each contain payload data, which is the data intended to be transmitted in the optical network, and header data, which includes data representing a destination to which the payload data is to be delivered. In this embodiment, the data representing a destination to which the payload data is to be transmitted is a network address such as a MAC address to which the source of the data packet wishes to transmit the payload data.

The received data packets are delivered to a destination mapping component 601. The destination mapping component 601 reads the header data each of the data packets to identify the network address to which the payload data of the data packet is intended to be transmitted. Often, the physical nodes and other network components that implement the resources associated with a particular network address in an optical network may change over time. Therefore, to identify the destination in the optical network (e.g. a node) to which the payload data is to be transmitted, the destination mapping component 601 looks up the network address identified by the header data of the data packet in a destination table 602. The destination table 602 stores a list of the network addresses that exist in the optical network and network destination identifiers that identify the components of the optical network (e.g. nodes) that implement the resources associated with those network addresses. The network destination identifiers may be, for example, identifiers of the nodes of the optical network (“node IDs”). The destination table 602 may be managed and updated by elements of the network external to the NIC 200 (as represented by the arrow labelled “AXI-L” in FIG. 6).

As discussed above, the optical network in this example transmits data in discrete time slots, which each have a fixed duration of 100 ns. (It will be appreciated that other slot durations may be chosen in different implementations, depending on the characteristics of the network in which the invention is being employed.) Each time slot corresponds to a certain quantity of data at a given rate of data transmission: for example, at a rate of 100 Gbps, a 100 ns time slot corresponds to about 1200 bytes of data. Additionally, the optical network divides time into epochs, which each contain a fixed number T of time slots. In this example, T=10. Thus, each epoch contains 10 slots of 100 ns each, such that each epoch has a duration of 1000 ns. A slot timer component 615 serves as a clock that informs the other components of the FPGA 202 of the current epoch and time slot.

The payload data of the received data packets must be distributed into data chunks of a size that can each be transmitted within one time slot. Often, the size of the payload data of a packet will exceed the data size of a single time slot, in which case the payload data must be split into multiple chunks each having a size no greater than the amount of data corresponding to a single time slot. An example of this is illustrated in FIG. 7: a data payload 701 having a size of 11400 bytes is divided into 10 chunks 711-720, nine of which 711-719 have a size of 1200 bytes each and the tenth of which 720 has a size of 600 bytes. When this data is transmitted over the optical network, each of the chunks will be transmitted in one respective time slot. It should be noted that, while the tenth data chunk 720 contains only a portion (in this case half) of the data volume that can be transmitted in one time slot, it is nonetheless treated as a discrete data chunk and will be transmitted in its own time slot. More generally, while each data chunk comprises no more data than can be transmitted within one time slot, the data chunks need not all be of the same data size. Where a data chunk comprises less data than the data size of a time slot, it nonetheless occupies the whole time slot (such that no other data will be transmitted with that data chunk within its respective time slot when it is transmitted over the optical network). Thus, while the payload data of a data packet may have a data size that is not an integral multiple of the data size of one time slot, it will nonetheless be divided into a number of data chunks that occupy a corresponding, integral number of time slots.

In some instances, the size of the payload data of the packet may be less than the data volume that can be transmitted in one time slot. In these cases, the payload data may be placed into a single data chunk (for example, a data payload of 600 b would result in one data chunk corresponding to the data chunk 720 shown in FIG. 3).

In the FPGA 202, the dividing of the payload data of the data packets into data chunks is performed by a packet chopping and tagging component 603. The packet chopping and tagging component 603 divides the payload data of the packets, in the manner illustrated above with reference to FIG. 3, into data chunks each of a size that can be transmitted over the optical network in one time slot. It will be appreciated that “dividing” the payload data into data chunks includes the scenario in which the entire payload of the packet can be contained within one time slot, in which case the whole payload is placed into one data chunk.

The packet chopping and tagging component 603 tags each data chunk with the network destination identifier of the network destination of the data packet from which the chunk was generated (as determined by the destination mapping component 601) and a timestamp identifying the epoch and time slot during which the data chunk was generated from said data packet (referred to hereinafter as the “birth timestamp” of the data chunk). For example, to tag the data chunks, the packet chopping and tagging component may generate 603 header data containing the information with which the data chunk is to be tagged. This information is associated with the data chunk as it is conveyed through the subsequent components of the FPGA 202. As discussed above, the network destination identifier may be a node ID of a node in the optical network to which the payload data is to be transmitted.

The FPGA 202 is configured to request, from the DSU, grants of slots for transmitting each of the data chunks over the optical network. The requests for grant of time slots are generated by a grant request generator component 604. One request for grant of time slots is generated for each data chunk and each respective request for grant of time slots contains the following information: (i) the birth timestamp of the data chunk (i.e. the epoch and time slot during which the data chunk was generated), and (ii) the network destination identifier (e.g. node ID) of the node to which the payload data is to be transmitted. This information is received by the grant request generator 604 from the packet chopping and tagging component 603. For the set of data chunks 711-720 shown in FIG. 7, which each come from the same data packet 701 and therefore have the same network destination and birth timestamp, 10 slots would be requested (using 10 requests for grant of time slots) since there are 10 data chunks 711-720.

The grant request generator component 604 controls the transceiver 651 to transmit the requests for grant to the DSU. For each request for grant of time slots that is transmitted, the birth timestamp and network destination identifier associated with the request for grant of time slots are stored in a request and grant table 605, which has the purpose of keeping a record of all the grants requested by the NIC 200. The birth timestamp and network destination identifier are sent to the request and grant table 605 by the packet chopping and tagging component 603. The DSU processes the requests for grant of time slots received from all the nodes of the optical network and, as discussed above, is configured to grant time slots to each node such that each node never receives data from more than one other node at the same time when the data chunks are transmitted over the optical network during the slots granted to them. The DSU returns time slot grants to the NIC 200, which are delivered to a grant receiver component 609 of the FPGA 202 by the transceiver 651. Each time slot grant informs the NIC 200 of a specific, future time slot and epoch in which the NIC 200 is permitted to transmit a data chunk to a specific network destination (e.g. node ID). Each time slot grant includes the following information: (i) the birth epoch of the data chunk contained in the corresponding request for grant (it should be noted that, in this example, the time slot grant does not include the birth time slot of the data chunk), (ii) the network destination identifier of the destination of the payload data contained in the corresponding request for grant, (iii) the time slot being granted, and (iv) the epoch of the time slot being granted. The grant receiver component 609 stores the received time slot grants in the request and grant table 609. The birth epoch and the network destination identifier of the data chunk contained in the time slot grant allow the corresponding request for grant to be identified in the request and grant table (by identifying a request for grant with the same birth epoch and network destination identifier). Where there are several requests for grant with the same birth epoch and network destination identifier, a corresponding number of time slot grants with that birth epoch and network destination identifier will be received. In the request and grant table, these time slot grants may be matched to those requests for grant in the order in which the requests for grant are stored in the request and grant table. The process by which the FPGA 202 ensures that each data chunk is transmitted during the time slot granted to it will now be explained.

After each data chunk has been generated and tagged by the packet chopping and tagging component 603, it is written to a buffer memory 650 by a write memory component 606 of the FPGA 202. The buffer memory 650 is not part of the NIC 200 in this example and is in communication with the NIC 200 via an electronic data connection. However, in other embodiments, the buffer memory 650 may be a component of the NIC 200. When the data chunk is written to the buffer memory 650, a buffer token representing the data chunk is stored, together with the memory address of data chunk in the buffer memory, by a buffer tokens component 607. The buffer token contains the birth timestamp of the data chunk and the network destination identifier of the data chunk. The buffer token is stored by the buffer token component 607 in a buffer token table together with a pointer to the location of the data chunk in the buffer memory and a value representing the length of the data chunk in the buffer memory. This information allows the data chunk to be looked up and retrieved from the appropriate memory address in the buffer memory when required.

The buffer memory 650 in the first aspect of the present disclosure may be referred to as a “transmit buffer memory” to distinguish it from other buffers and memories that may be present in some embodiments.

The FPGA 202 comprises a read grant component 611, the role of which is to retrieve information about the granted time slots from the request and grant table 605 to enable the data chunks to be retrieved from the buffer memory 650 at the appropriate time for onward transmission over the optical network. The read grant component 611 monitors the current epoch and slot (which are provided by the slot timer 615) and periodically (e.g. during each slot) reads the grant table to identify time slot grants that are a certain distance into the future relative to the current slot and epoch. For example, the read grant component 615 might look one epoch ahead, such that during each slot in the current epoch it identifies time slot grants for the corresponding slot in the next epoch (e.g. during the fifth slot in the current epoch, looking for time slot grants for the fifth slot in the next epoch). The read grant component 615 retrieves, from the request and grant table 605, the birth timestamp and network destination identifier of any data chunks that have been granted slots in the future slot to which the read grant component 615 is currently looking ahead. The read grant component 611 uses this information to instruct a read memory component 608 to retrieve the data chunks from the buffer memory. The read memory component 608 does this by looking up the memory address of the relevant data chunks in the set of memory addresses stored by the buffer token component 607 using the address in the buffer memory 650 that is stored with the birth timestamp and the network destination identifier of the data chunk (which, as discussed above, form the buffer token with which the address of the data chunk in the buffer memory 650 is indexed). Once the data chunk has been read from the buffer memory 650, the corresponding buffer token is removed from the list of buffer tokens stored by the buffer token component 607. The buffer token component 607 allows data chunks to be stored in any memory address of the buffer memory 650 that does not have an associated buffer token 607, so removing the buffer token of the data chunk signifies that the associated memory address is available for storing future data chunks.

The FPGA 202 comprises a plurality of transmit buffers 612, 613, each of which configured to store the next few data chunks (e.g. the next 10 data chunks) that are to be transmitted by a respective one of the transceivers 652, 653.

A destination to transceiver ports component 610 maintains a record of which of the transceivers 652, 653 addresses each of the network destinations represented in the destination table 602. (This information is obtained and updated using the same externally managed source of information as the destination table 602.) Using this information, the read grant component 611 causes the data chunks read from the buffer memory 650 by the read memory component 608 to be placed into one of a transmit buffer 612, 613 associated with the transceiver 652, 653 that addresses the network destination of the data chunk. For example, a data chunk intended to be transmitted to a network destination addressed by the transceiver 652 would be placed into the transmit buffer 612. It is advantageous that there are a plurality of transceivers 652, 653 and transmit buffers 612, 613 since such configurations support data bonding (i.e. transmission of data for one destination via multiple, parallel channels, enabling higher bandwidths than a single channel).

The read grant component 611 controls the transmit buffers to transmit each data chunk to the associated transceiver 652 during the time slot that was granted for the data chunk. Consequently, each data chunk is transmitted to the correct destination (as determined by the DSU) during the time slot granted to it. It will be noted that the FPGA 202 does not control the wavelength of the laser 106 or the state of the switch 110 used to transmit the data chunk, which both influence the destination that any signal transmitted by the transceiver arrives at. These parameters (the wavelength of the laser 106 and the state of the switch 110) are controlled by the NIC 200 using information received from the DSU separately to the time slot grants that are provided to the FPGA 202.

Typically, the transmit buffers 612, 613 are first-in-first-out memories configured such that data chunks are transmitted from each transmit buffer 612, 613 to the respective transceiver 652, 653 in the same order in which the data chunks were placed into the transmit buffer 612, 613. Consequently, the order in which the data chunks are transmitted from each transmit buffer 612, 613 to the transceivers 652, 653 is the same as the order in which the data chunks stored in that transmit buffer were stored in the transmit buffer 612, 613.

It will be appreciated that the write memory component 606 and read memory component 608 of the FPGA 202 are the functions of the FPGA 202 that operate to cause the data chunks to be written to and read from the buffer memory 650. They do not necessarily comprise the physical hardware, if any, involved in reading and writing to the buffer memory 650.

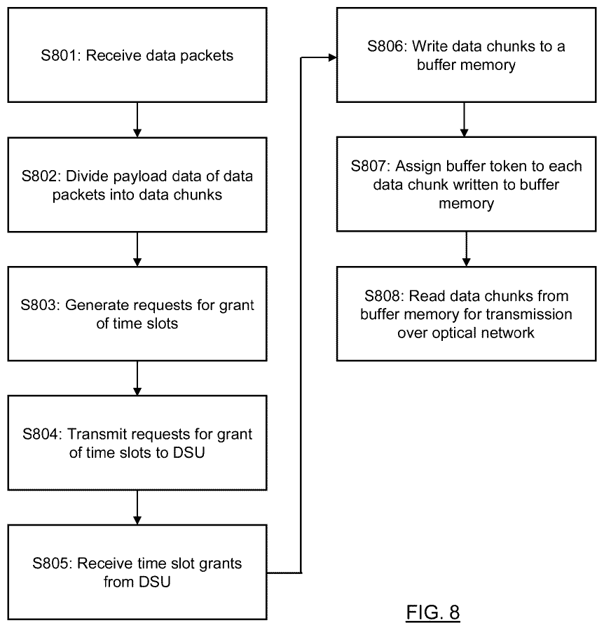

FIG. 8 is a flow chart illustrating the steps of a method of preparing data for transmission in a network in accordance with an embodiment of the present disclosure. The network is preferably an optical network. This method can be performed by the FPGA 202 shown in FIG. 6, as will now be described.

In step S801, a plurality of data packets are received from a data source, each data packet comprising payload data to be transmitted over the network and header data comprising data representing a destination to which the payload data is to be delivered. This step is implemented by the FPGA 202 of FIG. 6 when the FPGA 202 receives the data packets to be transmitted as described above.

In step S802, the payload data of the data packets is divided into a plurality of data chunks, wherein each data chunk is configured to be transmitted over the network in a respective time slot to be assigned to the data chunk. This step is implemented by the packet chopping and tagging module 603 of the FPGA 202 of FIG. 6. Preferably, the data identifying the destination of the payload data in each data packet is a network address and step S802 comprises, looking up the destinations of the payload data of each of the data packets in a destination table that comprises mappings of the destinations of the payload data of the data packets to network destinations in the network, and tagging each data chunk with a network destination identifier which identifies the network destination mapped in the network destination table to the destination of the payload data of the data packet from which the data chunk was generated. The data identifying the destination of the payload data in each data packet is preferably a network address, such as in the example described above with reference to FIG. 6. In the FPGA 202, the destination table is implemented by the destination table component 602. The network destinations are preferably nodes in the network (which is preferably an optical network).

Furthermore, it is preferred that, in step S802, each of the data chunks is further tagged with a timestamp identifying a time at which the data chunk was generated from said data packet. This is implemented by the packet chopping and tagging component of the FPGA 202.

Step S803 comprises generating requests for grant of time slots for transmitting the data chunks over the network to network destinations in the network corresponding to the destinations represented in the header data of the data packets. Then, in step S804, the requests for grant of time slots are transmitted to a DSU. These steps are implemented by the grant request generator component 604 of the FPGA 202 (employing the transceiver 651 to transmit the requests to the DSU). Preferably, for each data chunk, a respective request for grant of time slots is generated (in other words, one request for grant of time slots is generated per data chunk), wherein each request for grant of time slots comprises the network destination identifier and the timestamp with which the data chunk is tagged. Preferably, the timestamp comprises an epoch, and a time slot within said epoch, during which the data chunk was generated from the respective data packet. Step S803 preferably further comprises storing the generated requests for grant of time slots in a request and grant table. In the FPGA 202, this request and grant table is implemented by the request and grant table 605.

In step S805, time slot grants are received from the DSU, the time slot grants defining time slots in which data chunks are permitted to be transmitted to network destinations specified by the time slot grants. Each of the received time slot grants preferably comprises data identifying a time interval during which the corresponding request for grant of time slots was generated. This step is implemented by the grant receiver component 609 of the FPGA 202. The time interval is preferably the epoch during which the corresponding request for grant of time slots was generated, as in the example described above with reference to FIG. 6.

In step S806, the data chunks are written to a buffer memory. This step is implemented by the write memory component 606 of the FPGA 202.

In step S807, a respective buffer token is assigned to each of the data chunks written to the buffer memory and a mapping between each buffer token and the memory address of the respective data chunk in the buffer memory is recorded. This step is implemented by the buffer tokens component 607 of the FPGA 202. Each buffer token preferably comprises data identifying the network destination of the data packet from which the chunk was generated and a timestamp identifying a time at which the data chunk was generated from said data packet.

Step S808 comprises reading, using the buffer tokens, the data chunks from the buffer memory for transmission over the network in accordance with the received time slot grants. This step is implemented by the ready memory component 608 of the FPGA 202. Preferably, reading the data chunks from the buffer memory in accordance with the received time slot grants comprises, for each received time slot grant: for each received time slot grant, looking up, in the request and grant table (e.g. the request and grant table 605 of the FIG. 6 FPGA 202), a request for grant of time slots comprising the time interval identified by the time slot grant and having the same network destination; and reading from the buffer memory the data chunk for which said request for grant of time slots was generated.

Preferably, assigning each buffer token to its respective data chunk in step S807 comprises storing the buffer token in a buffer token storage, and the method further comprises removing the buffer token from the buffer token storage after the respective chunk has been read from the buffer memory in step S808.

The method optionally comprises, after step S808, storing the data chunks read from the buffer memory in one or more transmit buffers that are in communication with one or more transceivers configured generate signals for transmitting the data chunks over the network; and transmitting the data chunks from the transmit buffers to the transceivers for transmission over the network by the transceivers. (Preferably, the network is an optical network and the signals generated by the transceivers are optical signals.) In the FPGA 202 of FIG. 6, this is implemented by the read memory component 608 and the transmit buffers 612, 613. Preferably, for each transmit buffer, the data chunks stored in the transmit buffer are stored in an order corresponding to the temporal order of the time slots in which those data chunks are to be transmitted. Furthermore, the transmit buffers are preferably first-in-first-out memories, such that the order in which the data chunks are transmitted from each transmit buffer to the transceivers is the same as the order in which the data chunks stored in that transmit buffer were stored in the transmit buffer.

It should be noted that the method steps of FIG. 8 are not necessarily performed in the precise order shown in the FIG. 8 flow chart. For example, steps S803, S804 and S805 (generating requests for grant of time slots, transmitting the requests to the DSU, and receive time slot grants) may be performed simultaneously with steps S806 and S807 (writing the data chunks to the buffer memory and assigning buffer tokens to the data chunks).

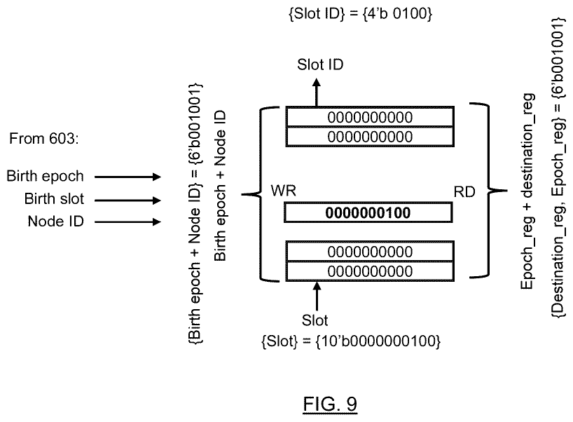

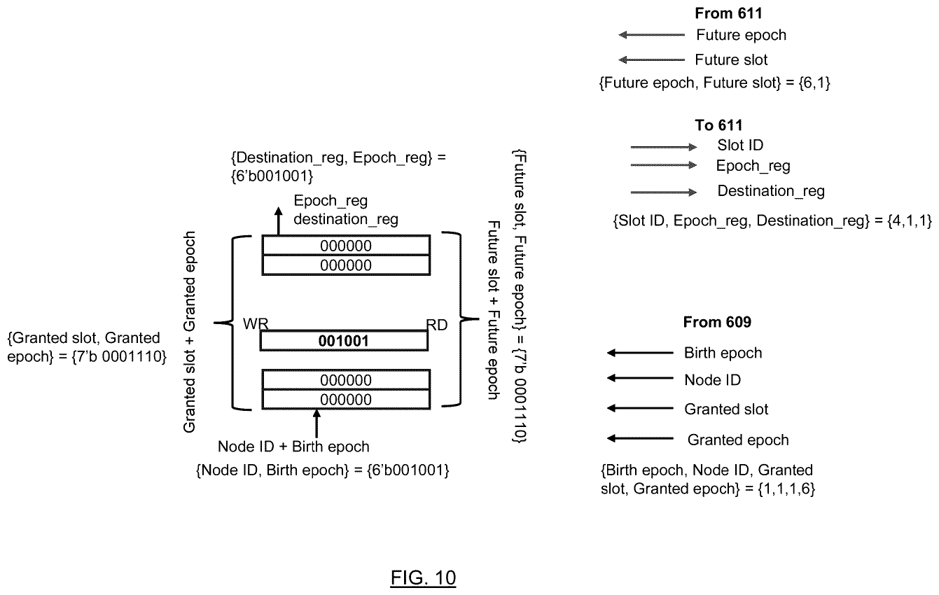

FIGS. 9 and 10 illustrate how the requests for grant of time slots and the time slot grants are stored in the request and grant table 605 in an embodiment of the present disclosure. As shown in FIG. 9, for each data chunk generated by the packet chopping and tagging module 603, the request and grant table 605 receives the epoch and time slot during which the data chunk was generated (which together form the birth timestamp of the data chunk) and the network destination identifier (which in this example is a node ID and is labelled “Node ID”) with which the data chunk has been tagged. As shown in FIG. 10, the time slot grants received from the DSU are stored in the request and grant table 605 by the grant receiver component 609 and contain the birth epoch and network destination identifier of the data chunk for which the time slot grant was requested and the epoch and slot that have been granted for transmission of that data chunk by the DSU. As discussed above with reference to FIG. 6, the read grant component 611 monitors the request and grant table 605 for grants of slots for a particular future epoch and future slot. When any such slots are identified, the read grant component 611 retrieves from the request and grant table 605 the birth epoch (as “Epoch_reg”), birth time slot (as “slot ID”) and network destination identifier (as “Destination_reg”) of the data chunks for which time slot grants have been received and uses these to control the read memory component 608 to read the respective data chunks from the buffer memory 650.

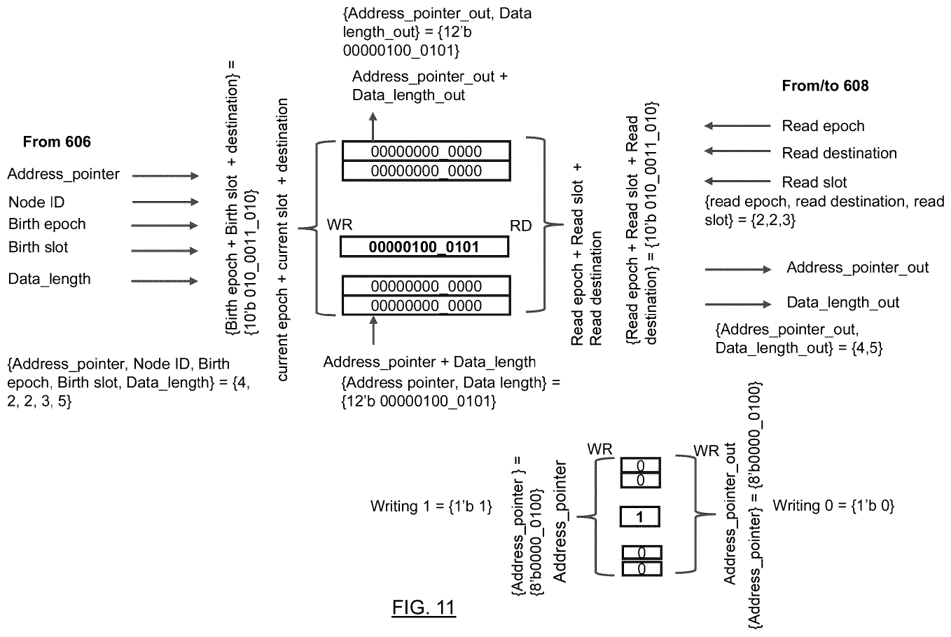

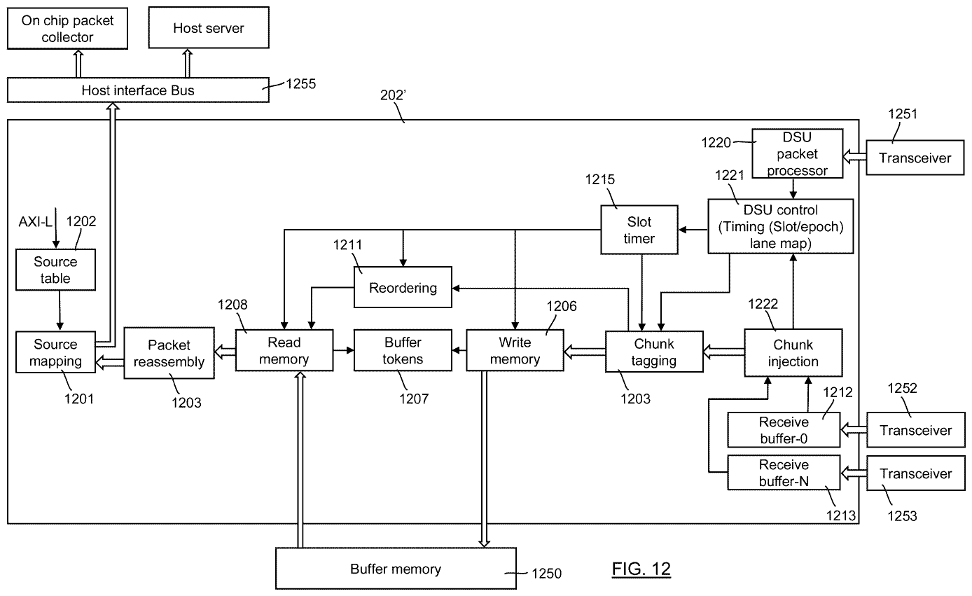

An example of the buffer token table maintained by the buffer tokens component 607 is shown in FIG. 11. When a new data chunk is written to the buffer memory 650 by the write memory component 606, the write memory component sends to the buffer tokens component 607 a pointer to the address of the data chunk in the buffer memory 650, the network destination identifier, birth epoch and birth slot of the data chunk, and the data length of the data chunk in the buffer memory 650. These values are stored as a 12-bit data object in the buffer token table. When reading a data chunk from the buffer memory 650, the read memory component retrieves the pointer (as “Address_pointer_out”) and data length (as “Data_length_out”) of the data chunk from the buffer token table by looking up the birth timestamp (as “Read epoch” and “Read slot”) and network destination identifier (as “Read destination”) of the data chunk in the buffer token table.

As shown in FIG. 11, the request and grant table also stores a one-bit flag for each memory address in the buffer memory 650, the value of which indicates whether that memory address is currently available. When the memory address is occupied, the value of the flag is set to 1. When the data chunk stored in the memory address has been read, the flag is set to 0, indicating that the memory address is available for a future data chunk to be written to it.

Preferred features of, and variants on, the embodiment of FIG. 6 will now be discussed.

### Priority-Based Data Handling

The data chunks may each carry a priority tag, which is used to communicate to the DSU the relative importance of the data chunk. The DSU may take this importance level into account when generating time slot grants. For example, the importance levels may be (from lowest importance to highest importance): P0 (e.g. for bulk, background transfer of data), P1 (normal), P2 (high), and P3 (urgent, reserved for latency-sensitive applications). The data chunks may be tagged with their respective importance levels by the FPGA 202 when they are generated, and this may be performed by the packet chopping and tagging component 603.

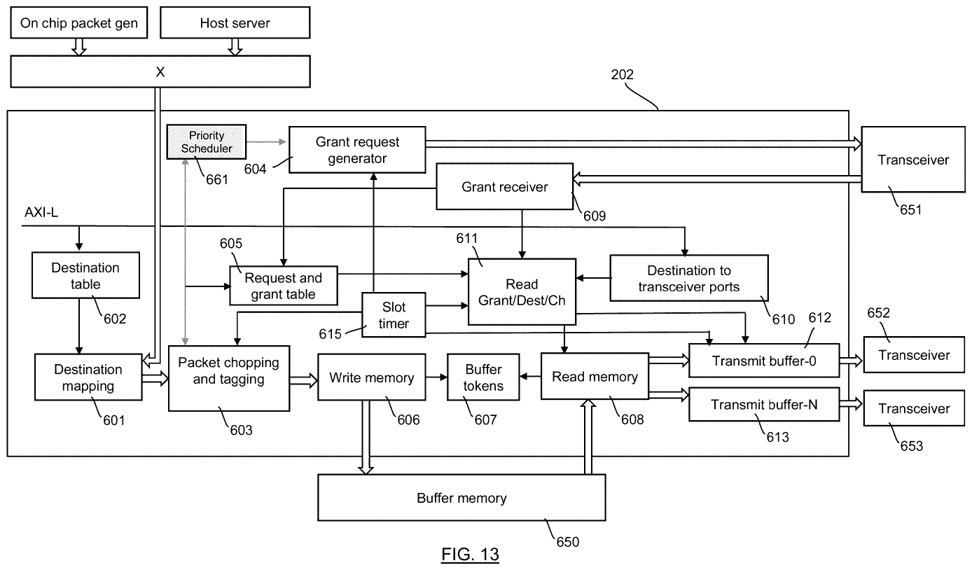

As well as being used by the DSU, the importance level may influence how the data chunks are processed by the FPGA 202. For example, the packet chopping and tagging component 603 may prioritise generating and tagging data chunks from data packets associated with higher-priority applications, the grant request generator component 604 may prioritise generating requests for grant of time slots for higher-priority data chunks represented in the request and grant table, and the read grant component 611 may be configured to prioritise reading of higher-priority data chunks from the buffer memory 650 for transmission over the network. The importance levels may map to quality of service (QoS) classes exposed to a host driver. A priority scheduler component 661, as shown in FIG. 13, may be provided for the purposes of controlling the packet chopping and tagging component 603, the grant request generator 604, and the read grant component 611 to implement these functions.

As an example, a latency-sensitive control stream (with importance level P3) and a bulk file transfer (with importance level P0) are destined for the same node. The packet chopping and tagging component 603 and the grant request generator 604 prioritise generating and sending requests for grant of time slots for the data chunks with the importance level P3. The DSU preferentially grants early slots for the data chunks tagged with the importance level P3. Once time slot grants for those data chunks have been received from the DSU, the read grant component ensures the P3 data chunks are transmitted first, while the P0 data chunks fill remaining granted time slots.

### Congestion Control Capabilities

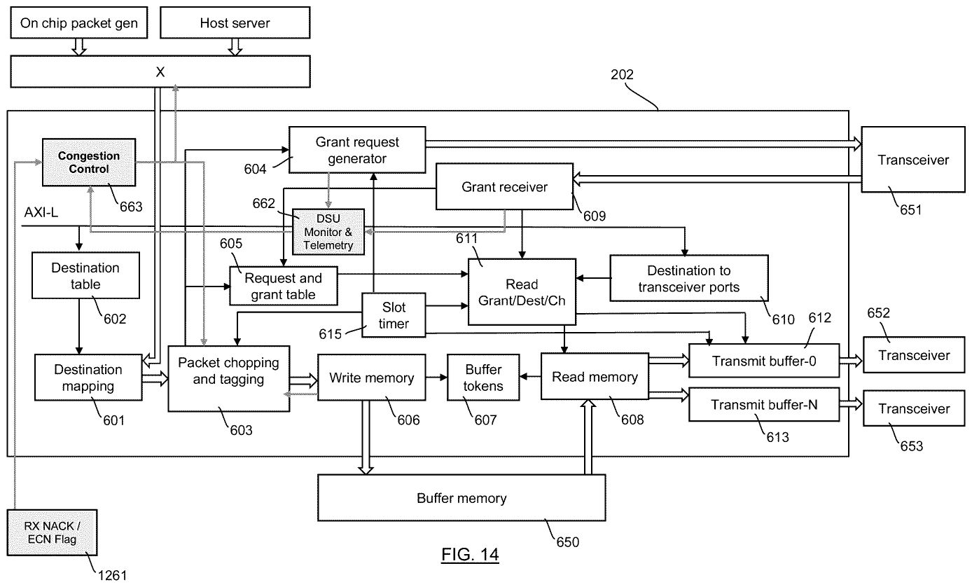

As shown in FIG. 14, the FPGA 202 may comprise a congestion control component 663 that is configured to regulate the rate at which the FPGA 202 generates data chunks from data packets and requests grant of time slots based on back-pressure signals. Such back-pressure signals may include the latency of the DSU issuing time slot grants (which may be sensed by the FPGA 202 or communicated to it by the DSU), the occupancy of the buffer memory 650 (e.g. the proportion of the capacity of the buffer memory 650 that is occupied by data chunks), and negative acknowledgment (NACK) or explicit congestion notification (ECN) flags 1261 generated by the destination nodes to which the data packets being processed by the FPGA 202 are destined. For the purposes of monitoring parameters such as the latency of the DSU issuing grants and occupancy of buffers such as the buffer memory 650, the FPGA 202 may comprise a monitoring and telemetry component 662.

Regulating the rate at which data chunks and requests for grant of time slots are generated as described above reduces the likelihood of conditions detrimental to the performance of the NIC 200, such as buffers (e.g. buffer memory 650) becoming full or overflowing or contention for popular network destinations.

For example, the FPGA 202 be configured to sense, for each destination node, the delay between requests for grant of time slots for that node ID being transmitted to the DSU and corresponding time slot grants being received from the DSU. This measuring may be performed by the monitoring and telemetry component 662. If the delay exceeds a predefined threshold for a particular node ID, the FPGA 202 may reduce or limit the rate at which new requests for grant of time slots for that node ID are generated. This could be achieved by, for example, limiting the rate at which the packet chopping and tagging component 603 generates new data chunks and/or limiting the rate at which the grant request generator component 604 transmits requests for grant of time slots for that node ID. As a further example, the occupancy of the buffer memory 650 may be monitored (by the FPGA 202 or another component of the NIC, such as by monitoring the number of buffer tokens stored at the current time by the buffer tokens component 607), and the rate at which data chunks are generated by the packet chopping and tagging component 603 may be reduced or limited so as to prevent the buffer memory from overflowing. The packet chopping and tagging component 603 may also be configured to merge small packets before dividing them into data chunks in response to the back-pressure signals, so that fewer partially-filled data chunks are produced, thereby reducing the overall number of data chunks produced. If the priority-based data handling mechanism described above is being employed, the FPGA 202 may be configured to temporarily deprioritise non-urgent traffic.

Each of the back-pressure signals and control measures discussed above may be implemented per destination, such that, for example, if one destination node is heavily congested, processing of data to be transmitted to that destination may be temporarily regulated while data directed to other network destinations may continue as normal.

### Aging Mechanism for Memory Management

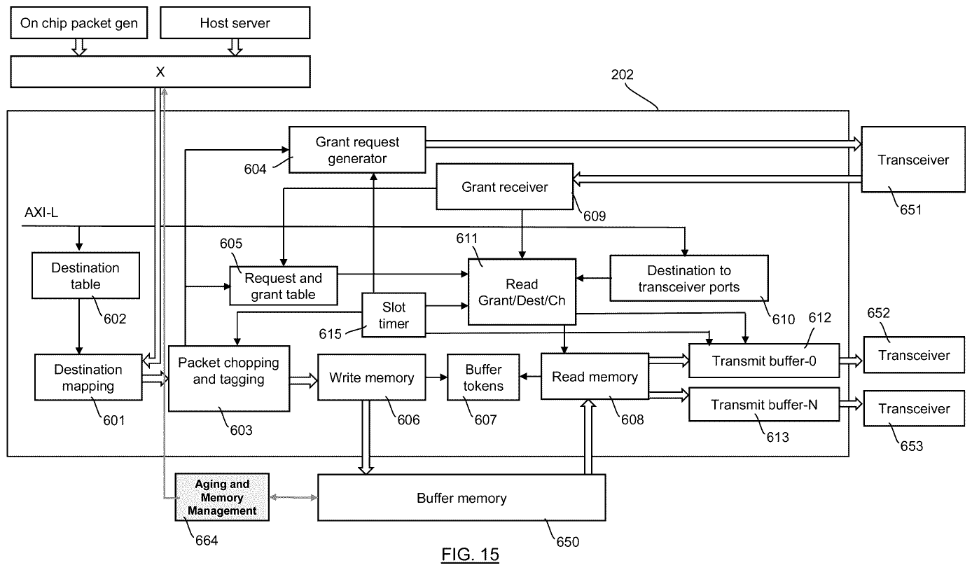

The NIC 202 may comprise an aging and memory management component 664, as shown in FIG. 15. This component is configured to monitor the age of each buffer token and the corresponding request for grant of a time slot, measured as the time between the birth epoch and time slot of the data chunk and the current epoch and time slot. Data chunks whose buffer token exceeds a certain age (e.g. a predetermined number of epochs) may be cleared by cancelling the request for grant of a time slot and discarding the buffer token so as to free the space in the buffer memory 650 occupied by the corresponding data chunk. This prevents data chunks and their corresponding buffer tokens and requests for grant of time slots being stored indefinitely in situations such as when the destination node to which the data chunk was directed goes offline. Typically, the host will be informed that the data packet to which the aged data chunks belong is aging and will then re-examine its current priority and re-generate fresh data with requests of higher priority. Monitoring aging across the whole buffer memory consistently is advantageous as a way of measuring system performance.

As an example, a node in the network, for which requests for grant of time slots are pending in the request and grant table 605, goes offline mid-transfer. Requests for grant of time slots linked to that node cannot be fulfilled and therefore receive no time slot grants. After X epochs (where X is a configurable number), the FPGA 202 marks those tokens as expired, notifies the host server (status queue), and clears the data chunk and its associated buffer token and request for grant of a time slot. The host server may retry (by re-sending the corresponding data packet to the FPGA 202), reroute the data packet to a different destination, or drop the flow.

Where the priority-based data handling mechanism described above is employed, a different aging policy may be implemented for each priority (such that higher-priority data chunks time out sooner) and can trigger host interruptions or counters for observability. Optionally, expired data chunks may be quarantined for diagnostics before final reclamation.

### Batching of Requests for Grant of Time Slots

In the embodiment described above with reference to FIG. 6, the grant request generator component 604 generates an individual request for grant of a time slot for each data chunk produced by the packet chopping and tagging component 603. In an alternative implementation, the FPGA 202 may be configured to transmit requests for multiple time slot grants associated with the same destination node in a single message.

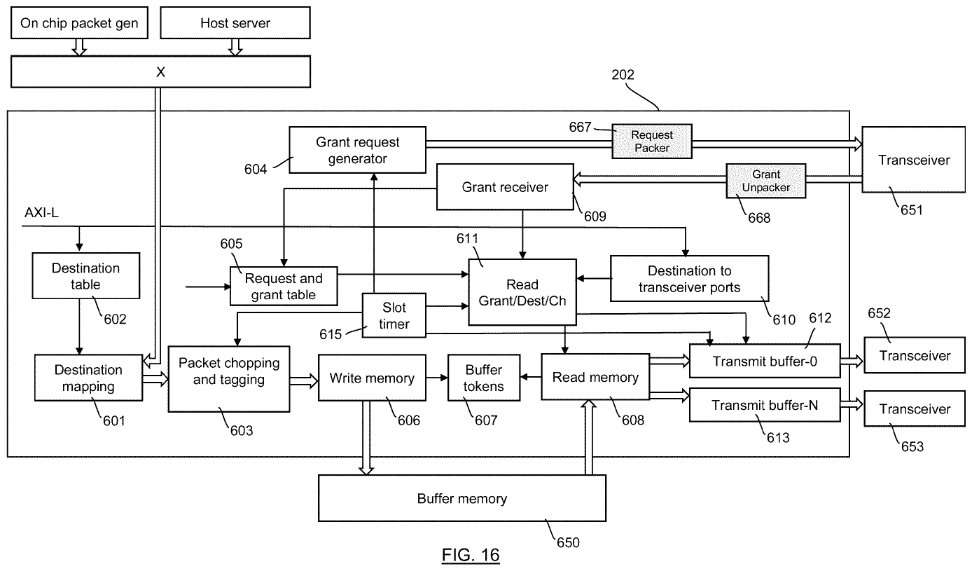

For example, a data packet destined for a particular destination node, node C, may be divided into 32 data chunks by the packet chopping and tagging component 603. Accordingly, 32 requests for grant of time slots are recorded in the request and grant table 605. However, instead of transmitting 32 individual requests for grant of time slots to the DSU, the FPGA 202 is configured to transmit to the DSU a batched request message, indicating the node ID of the destination node and the number of time slot grants being requested (32 time slots for node C). For this purpose, a packer component 667, shown in FIG. 16, configured to generate the batched request message may be provided. The grant request generator component 604 may generate the individual requests for grant of time slots as usual, but the packer component may, in response to identifying multiple requests for grant of time slots directed to the same destination node, generate a batched request message and transmit it to the DSU in place of the individual requests for grant of time slots. Sending a single, batched request message in place of several individual requests for grant of time slots reduces overheads and improves control-plane efficiency.

In addition to identifying the destination node ID and the number of time slot grants being requested, the batched request message may additionally identify a preferred time window (e.g. a preferred range of epochs, such as epochs N to N+3) for the time slot grants to be issued for. The batched request message may be implemented as a fixed-width TLV, which comprises the node ID of the destination node for which the grant of time slots is being requested, the range of birth epochs of the data chunks for which the grant of time slots is being requested, the number of data chunks, and optionally also the importance level of the data chunks.

The DSU may be configured to respond to the batched request message by issuing, instead of individual time slot grants, a batched grant message, which identifies a set of time slots being granted in response to the batched request message. For example, the batched grant message may be a bitmask grant replace, which defines a slot map identifying, for each epoch, the slots being granted. An unpacker component 668 may be provided, which is configured to receive the batched grant message, generate individual time slot grants corresponding to the time slots identified by the batched grant message, and transmit the time slot grants to the grant receiver component 609, which then stores the time slot grants in the request and grant table 605 as described above.

An embodiment of the second aspect of the present disclosure will now be discussed.

FIG. 12 schematically illustrates an FPGA 202′ of a NIC configured to implement a method of receiving data transmitted over a network, in accordance with an embodiment of the second aspect of the present disclosure. The FPGA 202′ is configured to receive data chunks transmitted via the network, such as by a node comprising a NIC configured to transmit data over the network as illustrated in FIG. 6, and assemble the data chunks into data packets, which are then delivered to their final destination, such as a host server. The received data chunks are typically portions of the payload data of data packets that were divided into data chunks by the node that transmitted them, as described with reference to FIG. 6.

Typically, the NIC that comprises the FPGA 202′ will be comprised by a node in the network and will be configured to receive data chunks transmitted to it, over the network, by other nodes in the network. Typically, the network will be an optical network, as described above.

The NIC which comprises the FPGA 202′ typically will have the configuration illustrated by FIGS. 2 and 3 and will be described with reference to this configuration. Thus, the NIC is configured as shown in FIG. 3, except that the FPGA (which is shown in FIG. 3 as being the FPGA 202 of FIG. 6) is configured to implement the functions of the FPGA 202′ shown in FIG. 12 in addition to, or instead of, those of the FPGA 202 shown in FIG. 6. In particularly preferred implementations of the NIC 200 of FIG. 3, the FPGA of the NIC 200 is configured to perform the functions of both the FPGA 202 of FIG. 6 and the FPGA 202′ of FIG. 12, such that the NIC 200 is capable of transmitting data over the network in accordance with the method of the first aspect of the present disclosure and receive data transmitted over the network in accordance with the method of the second aspect of the present disclosure.

It will be understood that, while FIG. 12 shows the FPGA 202′ as comprising various components (e.g. a source mapping component 1201 and a source table component 1202), these components do not necessarily represent distinct physical entities in the FPGA. Rather, FIG. 12 is a schematic representation that illustrates the various processes that the FPGA 202′ in this embodiment is configured to perform. The term “component” in this context may thus signify a part of the programming of the FPGA 202′ rather than a distinct physical element.

The FPGA 202′ is in communication with a plurality of transceivers 1251, 1252, 1253 and a buffer memory 1250, the function of which will be discussed below. The transceivers 1251, 1252, 1253 are configured to receive data chunks transmitted to the NIC over the optical network. The transceiver 1251 is used to communicate with the DSU for purposes such as receiving control data from the DSU. The transceivers 1252, 1253 are used to convert optical signals received by the receive datapaths of the NIC and detected by the respective photodetection devices 116 into electronic signals, which can then be processed by the FPGA 202'. Typically, the DSU is implemented by a node in the optical network and communications between the NIC 200 and the DSU are optical communications exchanged over the optical network. (In this case, specific epochs and/or slots may be reserved for requesting and receiving grants of slots.) In this scenario, the transceiver 1251 used to communicate with the DSU may be one of the transceivers 1252, 1253 used to receive data transmitted data over the optical network. For the purposes of illustration, however, FIG. 12 illustrates communications with the DSU being facilitated by a distinct transceiver 1251.

The transceivers 1251, 1252, 1253 and the buffer memory 1250 may be comprised by the node of the optical network in which the NIC 200 is incorporated. For the avoidance of doubt, in this embodiment, the components shown inside the box labelled 202′ in FIG. 12 are implemented by the FPGA 202′ of the NIC 200 (e.g. the designation mapping component 1201 and the destination table 1202) whereas the components outside of the box labelled 200 are not part of the FPGA (e.g. the transceivers 651, 652, 653).

The transceivers 1252, 1253 receive data chunks transmitted over the network. As mentioned above, the received data chunks may have been transmitted to the node that comprises the FPGA 202′ by other nodes in the network, each configured to transmit the data chunks as illustrated by FIG. 6.

The transceivers 1252, 1253 are configured to place the data chunks into respective receive buffers 1212, 1213, which are each configured to store, temporarily, a number of data chunks (e.g. up to 10). The provision of the receive buffers 1212, 1213 ensures that the received data chunks can be fed to the downstream components of the FPGA 202′ at a stable rate. It also compensates for any temporal skew between the different transceivers 1252, 1253 by buffering data chunks that have arrived early or late.

It is noted here that the data chunks received by the transceivers 1252, 1253 may have been transmitted in a data bonded fashion, i.e. such that data chunks belonging to the same data packet are received across multiple receive datapaths. (The term “lane” will be used in the discussion that follows to refer to the different receive datapaths, i.e. such that each of the transceivers 1252, 1253 implements a respective lane.)

From the receive buffers 1212, 1213, the received data chunks are processed by a metadata parsing component (or “metadata parser”) 1222, which extracts the raw data chunks from their respective receive buffers 1212, 1213 and has the role of obtaining metadata that will be used subsequently to reassemble the data chunks into data packets. In particular, the metadata parsing component retrieves the epoch and time slot in which the data chunk arrived, and marks each data chunk with the source node ID of the source node from which the data chunk was transmitted and the lane ID of the lane in which the data chunk arrived, if data bonding across multiple lanes is being employed. The metadata parsing component 1222 also reads metadata comprised by the data chunks, such as a flow ID, packet ID and chunk ID, which, as will be discussed below, may be employed when reassembling the data chunks into data packets. The metadata obtained by the metadata parsing component 1222 is used subsequently to generate buffer memory tokens for the data chunks when they are written to the memory buffer 1250, as will be discussed below.

The receive buffers will typically receive forms of data other than data chunks carrying the payload data of data packets being transmitted over the network. In particular, when control data packets arrive from the DSU in-band, the metadata parsing module 1222 reads the current DSU epoch and time slot from the control data packets. (Techniques for handling control data from the DSU received in-band and out-of-band will be discussed below.) The metadata parsing component 1222 uses the known DSU time to align incoming chunks to the DSU time domain as it reads them from the receive buffers 1212, 1213, such that the epoch and time slot of arrival that are assigned to the data chunk correspond to the current epoch and time slot according to the DSU.

In implementations in which data bonding across several lanes is performed, the metadata parsing component 1222 has a role in ensuring that data chunks belonging to the same data packet but received across several different lanes are reassembled into the correct order. In this scenario, the metadata parsing component 1222 may retain the metadata (e.g. epoch and time slot of arrival, source node ID, lane ID, chunk ID, and packet ID) of each of the received data chunks while awaiting the other data chunks belonging to the same data packet. This is done so that, even where data chunks belonging to a data packet are received out of sequence and across several different lanes, their correct order can be computed and used to reassembled them into the correct sequence.

After being placed into the internal metadata format, the data chunks are tagged with metadata by a chunk tagging component 1203. The chunk tagging component tags each of the data chunks with metadata including (i) the epoch and time slot in which the data chunk was received, (ii) a source node ID identifying the node from which the data chunk was received, and (iii) if data bonding across multiple lanes is being performed, a lane ID identifying which of the lanes the data chunk was received by. How each of these items of metadata is obtained will not be discussed.

The chunk tagging component 1203 obtains the epoch and time slot of arrival of the data chunk from a slot timer component 1215, which serves as a clock that maintains the current epoch and time slot, and emits timing ticks to the other components. (In the case of a network interface module configured to implement the methods of both the first aspect and the second aspect, the slot timer component 615 of FIG. 6 and the slot timer component 1215 of FIG. 12 may be implemented by a single slot timer component.) The slot timer component 1215 communicates with a DSU control component 1221, which has the role of holding the active network control state as communicated to it by the DSU. For this purpose, the DSU control component 1221 is configured to receive control data from the DSU, which is delivered to the FPGA 202′ via the transceiver 1251 and is initially processed by a DSU packet processor component 1220. (As mentioned above, control data may also be transmitted from the DSU in-band, such that it arrives via the same transceivers 1252, 1253 as the data chunks, and control data received in this way is also delivered to the DSU control component 1221.) The DSU packet processor component 1220 is configured to detect whether data received by the transceiver 1251 during each time slot contains control data from the DSU (which typically will be transmitted by the DSU at a certain interval, such as in one slot per epoch). The control data may include information about the current epoch and time slot (which is used to update the slot timer component 1215, to ensure that the timing maintained by that component remains accurate), updates to the mapping of lanes to nodes within the network, and updates about the scheduling of data transmission within the network. The DSU control component 1221 maintains a mapping of lanes to source nodes as communicated to it by the DSU and the current epoch and time slot. It behaves as the canonical timing source for the components illustrated in FIG. 12, in that each time control data including the current epoch and time slot is received, the DSU control component 1221 broadcasts this timing information to the other components, including the slot timer 1215. The DSU control component 1221 may also provide lane group bonding information.

The chunk tagging component 1203 is provided with the source node ID of each data chunk from the DSU control component 1221, which obtains this information from the mapping of lanes to source nodes that it receives from the DSU. The lane ID is known from the metadata parsing component 1222 since the lane to which the data chunk was delivered corresponds to whichever one of the receive buffers 1212 the data chunk was retrieved from.

As noted above, each data chunk is output by chunk tagging module 1203 annotated with metadata identifying (i) the epoch and time slot in which the data chunk was received, (ii) a source node ID identifying the node from which the data chunk was received, and (iii) if data bonding across multiple lanes is being performed, a lane ID identifying which of the lanes the data chunk was received by. The data chunks are then written to a buffer memory 1250 by a write memory component 1206. The buffer memory 1250 has the role of buffering the data chunks while the FPGA 202′ computes the order in which the data chunks of each data packet are to be reassembled, as will be described below.

The buffer memory 1250 in the second aspect of the present disclosure may be referred to as a “receive buffer memory” to distinguish it from other buffers and memories that may be present in some embodiments.

When each data chunk is stored in the buffer memory 1250, a respective buffer token is created and is stored by a buffer tokens component 1207. Each buffer token identifies the respective data chunk and includes the following data: (i) the source node ID with which the data chunk was tagged, (ii) the epoch and time slot with which the data chunk was tagged, (iii) a pointer to the location of the data chunk in the buffer memory (which enables the data chunk to be retrieved from the buffer memory 1250 in future), (iv) the length of the data chunk (which enables the correct portion of the buffer memory 1250 to be read when the data chunk is retrieved from the buffer memory 1250), (v) a reordering window assignment (which assigns the data chunk to a specific reordering window, as will be discussed below), and (vi) a flow ID. The flow ID, which identifies a specific flow of data packets from a source in the network to the destination (such as a flow of data associated with a specific application), may be part of metadata comprised by the data chunk and may be read by the chunk tagging module 1203, as will be discussed below. The buffer token enables each chunk stored in the buffer memory to be identified (based on its source ID and arrival epoch and time slot) and read from the buffer memory 1250 (using the pointer to its memory location and the length of the data chunk).

To enable the data chunks to be reassembled into data packets, the order in which they are to be assembled must be determined. This role is performed by a reordering component 1211. For each data packet that is to be assembled, the reordering component 1211 defines a respective reordering window. As the data chunks are tagged by the chunk tagging component 1203, the reordering component 1211 assigns to each data chunk a sequence position within the reordering window of the data packet to which it belongs. The assigned sequence positions of the data chunks typically correspond to the original byte order of the data chunks within the data packets from which the data chunks were generated before being transmitted. The data chunks may comprise metadata identifying the flow and the specific data packet to which they belong, and their respective sequence positions within the respective data packet, such as a flow ID, as discussed above, a packet ID, which identifies the data packet to which the data packet belongs, and a chunk ID, for example a serial number or other data identifying the data chunk, from which the sequence position of the data chunk relative to other data chunks within the data packet may be inferred. The data chunks may each comprise respective header data which comprises this metadata. As noted above, the metadata may be read by the metadata parsing component 1222 and communicated to the reordering component 1211. (It is noted that embodiments of the first aspect of the present disclosure may comprise tagging the data chunk with this metadata before it is transmitted over the network. For example, in the FIG. 6 embodiment of the first aspect, the packet chopping and tagging component 603 may be configured to tag the data chunks that it generates with a respective flow ID, packet ID and chunk ID.)

When the reordering component 1211 determines that a reordering window is full (i.e. that each sequence position within the reordering window has been assigned to a data chunk stored in the buffer memory 1250), a read memory component 1208 reads those data chunks from the buffer memory 1250 (using the buffer tokens stored by the buffer tokens component 1207 to retrieve the appropriate data chunks). The retrieved data chunks are then assembled, in the sequence defined by the reordering window, into data packets by a packet reassembly component 1203. Since the data chunks are typically generated (by the node from which they originate, before being transmitted) from the payload data of a data packet generated by the source node, the data packets produced by the packet reassembly component 1203 typically correspond to the payload data of such data packets. Once the data packet has been assembled, the corresponding reordering window is flushed by the reordering component 1211. When data chunks are determined to be missing from a particular data packet or otherwise invalid, the packet reassembly component may discard that data packet, or mark it in such a way that communicates to the destination of the data packet (e.g. a host server) that data chunks are missing from the data packet.

Once the data packets have been assembled by the packet reassembly component 1203, they must be forwarded by the FPGA 202′ to the relevant host destination within the node to which the NIC comprising the FPGA 202′ belongs. For example, the data packets may be destined for a host server comprised by the node (represented by the “Host server” component illustrated in FIG. 12) or for a destination on the NIC (represented by the “On chip packet collector” component illustrated in FIG. 12), for purposes such as internal diagnostics, monitoring, loopback, control-plane, or local switching. To facilitate delivering the reassembled data packets to the appropriate destinations, the FPGA 202′ comprises a source mapping component 1201 and a source table 1202.

The source table 1201 stores a mapping of source IDs to host destinations. The source ID of the data chunks within the reassembled data packet is looked up in the source table 1202 by the source mapping component 1201. The source table 1202 may contain information about the host, tenant, session and flow to which the data packet belongs and a receive queue ID, identifying a direct memory access (DMA) queue to which the data packet is to be delivered. The source table 1202 may be updated by components of the network external to the NIC as the mappings of source nodes to destinations changes (as represented by the arrow labelled “AXI-L” in FIG. 12). Control software may be provided for the purpose of updating the source table 1202.

A host interface bus 1255 delivers the data packet to the appropriate host DMA queue, as identified by the receive queue ID. The host interface bus 1255 may be, for example, an AXI, PCIe, or custom bus. It has the role of forwarding the reassembled data packets to the appropriate DMA queue. It decouples host performance from the timing of the receive pipeline, thereby maintaining high throughput.

Typically, each node in the network will be configured to transmit data and receive data over the network. Therefore, advantageously, the NIC 200 of each node will typically be configured to implement the method of preparing data for transmission in the network illustrated by FIG. 6 and the method of receiving data transmitted in the network illustrated by FIG. 12 (and therefore processes data to be transmitted from the associated host server over the network and data to be received by the host server from other nodes in the network). As such, the FPGA comprised by the NIC is typically configured to implement the functions illustrated by FIG. 6 and those illustrated by FIG. 12. Such a NIC achieves the advantages of the present disclosure in relation to both data transmission and data receiving, in particular as they relate to the improvement in the rate at which data is processed achieved by the use of the buffer memories 650, 1250. The buffer memory 1250 may be implemented by the same hardware that implements the buffer memory 650 of FIG. 6.

Preferred features relating to the embodiments of FIG. 6 and FIG. 12 and the network within which they are implemented will now be discussed.

### Link/Channel Bonding

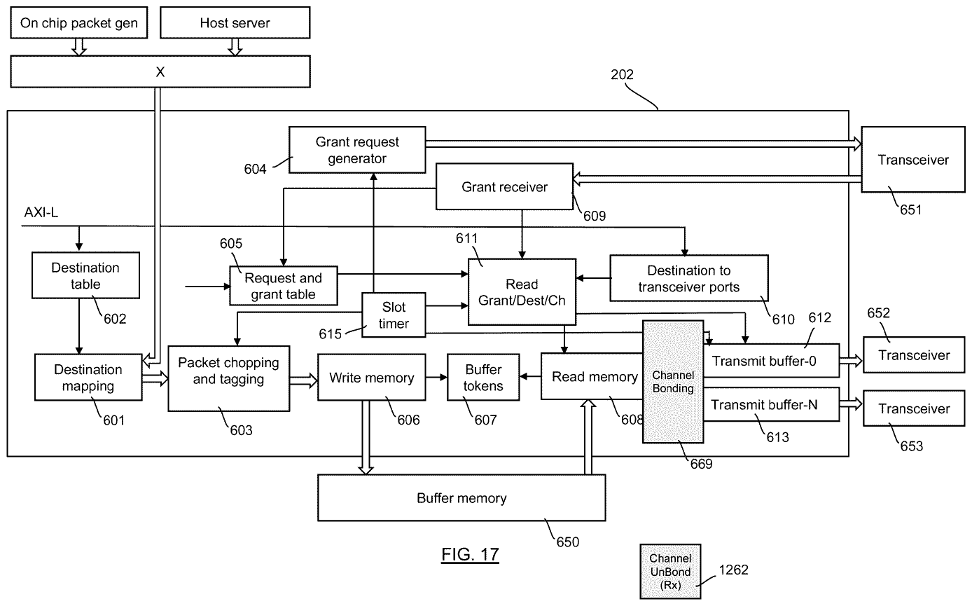

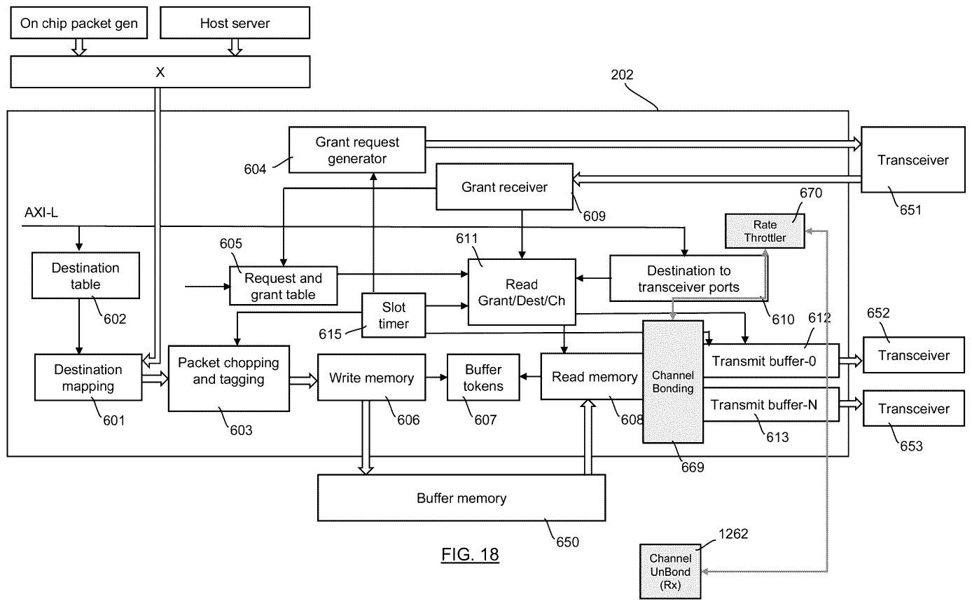

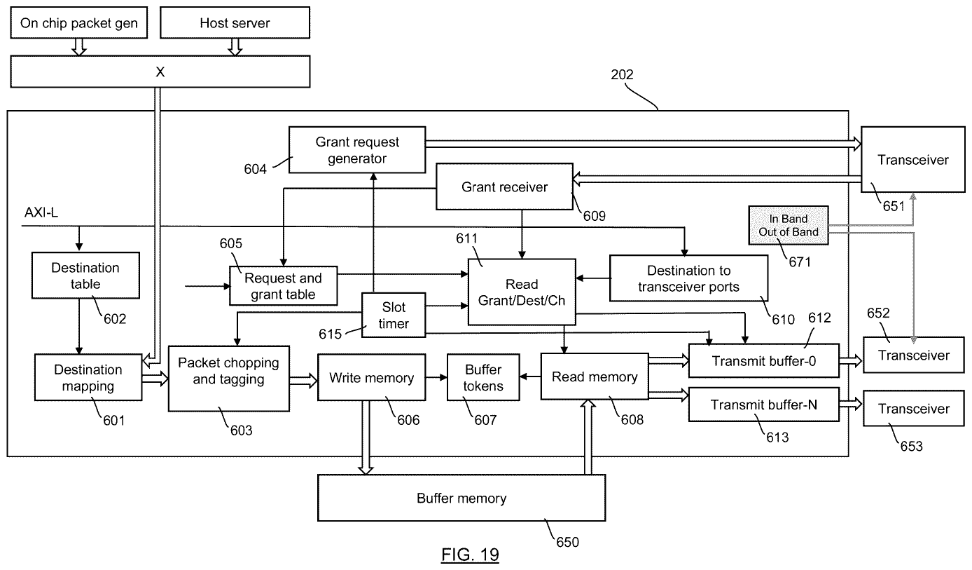

As discussed above, each NIC may transmit and receive data across several different lanes. The lanes may be implemented by different wavelengths or by different spatial paths in the network, for example. This enhances the effective bandwidth at which the NIC may operate since each lane may operate at the bandwidth of the network, and multiple lanes operating in parallel thus achieve an effective bandwidth corresponding to the sum of their individual bandwidths. The FPGA 202 of FIG. 6 may be configured to distribute data chunks belonging to the same data flow across several different lanes, while preserving the relative temporal sequence of the data chunks of each flow. (The data chunks of different flows may of course be multiplexed, as described above.) The data chunks may be tagged with sequence numbers for this purpose, or the DSU may coordinate mapping of time slots to individual data chunks and communicate this mapping to the NICs of the destination nodes (enabling, for example, the reordering component 1211 of the FIG. 12 FPGA 202′ to assign the data chunks to the correct sequence positions when they are received). As shown in FIG. 17, data bonding across different lanes of data to be transmitted may be performed by a channel bonding component 669 of the FPGA 202. A channel unbonding component 1262 may be provided (in the FPGA 202′ receiving the transmitted data) for unbonding the received data. As shown in FIG. 18, the FPGA 202 may comprise a rate throttler component 670 configured to receive feedback from the channel unbonding component 1262 and control the effective bandwidth implemented by the channel bonding component 669.

As an example, a 400 Gbps logical link may be formed by four 100 Gbps lanes, labelled lane 0, lane 1, lane 2, and lane 3, across which data chunks being transmitted to a particular destination node are distributed. The NIC of the destination node may receive the data chunks across the four lanes and use the sequence numbers of the data chunks to assign the data chunks to the correct sequence positions, corresponding to their original order, within their respective data packets when they are reassembled.

Lane-skew compensation buffers (which may be FIFO buffer memories) may employed by the NIC of the destination node for each of the lanes. Lane health monitoring may be implemented. The network may be configured such that lanes can be added and removed with graceful degradation.

### Multi Data Rate Capability

The network may be configured to facilitate changes in its bandwidth, which can be achieved without changing the timing scheme of time slots and epochs described above. For example, a deployment may migrate from 100 Gbps to 200 Gbps. The time slots may remain 100 ns in duration, but the quantity of data that can be transmitted within each slot doubles. Alternatively, the payload per time slot may be kept constant while the temporal duration of the time slots is halved. The duration of the time slots and the internal clock speed of the network are paramaterisable, enabling changes in bandwidth to be accommodated without altering the underlying logic as to how data is processed. In some implementations, timing registers (slot_ns, epochs_per_frame) may be defined, and FIFO depths and watermark thresholds may be derived from those settings.

### In-band and Out-of-band Communications

As discussed above, communications between the NICs of the nodes and the DSU may be in-band (e.g. sharing the same data-bearing optical fibre as the payload data transmitted between nodes of the network) or out-of-band (e.g. on dedicated optical fibres reserved for communication with the DSU). The mode of communications between the DSU and the nodes may also be selected dynamically, such that the manner of communication switches between in-band and out-of-band based on factors such as load or link health. Out-of-band communication may be used in the event of failover or high load. In each case, the scheduling logical of the NIC remains the same and can be configured to the transport choice. Dynamic selection of the mode of communication with the DSU may be implemented by a DSU communication control component 671.

For example, during a data burst, in-band control might be congested. The NIC preparing data for transmission therefore temporarily redirects DSU messaging to an out-of-band control fibre, maintaining timely scheduling without consuming bandwidth that would otherwise be available for transmitting payload data.

### Integration of Optical Components

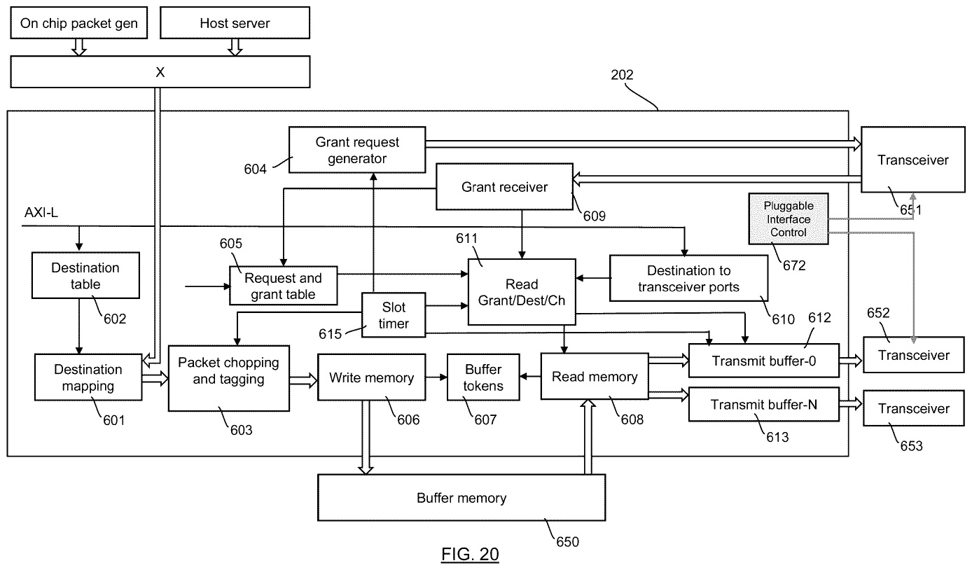

With reference to the configuration of the NIC 200 illustrated in FIG. 3, in some implementations, a register or API layer is provided to enable the FPGA 202 to configure the optical engine 208, including the tunable lasers, modulators, optical switches, and filters. The FPGA 202 may program wavelengths per slot and select output port routes. For example, for a granted time slot targeting a specific rack, the FPGA 202 sets a laser to a wavelength λX associated with the rack and the corresponding switch state S(X) one guard cycle before the slot. The path is established just-in-time for transmission. Deterministic timing constraints may be provided: for example, ‘config-apply’ occurs at a time≥Tsetup before time slot edge. Calibration and health telemetry (power, temperature, lock status) may be included. The control of the optical components by the FPGA 202 may be implemented by a pluggable interface control component 672, shown in FIG. 20, to which communicates with a pluggable control interface to which the optical components are connected. Specificat

[symbol]

### Configuration of Wavelength and Time Slots by FPGA

The time slot schedule and wavelength plan may be coupled. The time slot grants issued by the DSU may include both the granted time slot and epoch and optical parameters (specifically a target wavelength and a switch port). The FPGA 200 commits both before emitting the data chunk. For example, a grant of a time slot may include {Epoch 10, Time Slot 3, destination=Node 17, λ=1550.12 nm, Port=2}. The FPGA 202 loads the wavelength and port settings into the optical components just ahead of Slot 3, then transmits the chunk to Node 17.

### Integrated Optics Configuration for Routing and Destination

The final destination of a data chunk is determined by a combination of the time slot granted by the DSU and optical steering (wavelength and switch). This ensures precise, collision-free routing across shared passive components (e.g. AWGRs). For example, if two source nodes aim at the same rack in adjacent slots with different wavelengths; each reaches a different server due to AWGR wavelength-to-port mapping while time-division prevents collisions.

### Compatibility With DMA Engines (e.g. QDMA)

The FPGAs 202, 202′ may be configured to operate as a standalone, agnostic, plug-and-play component situated between DMA and the optical components of the NICs. Standard DMA engines (e.g. QDMA/AXI DMA) deliver buffers; the packet chopping and tagging component 603 converts them into data chunks; the

DSU handles requests for grant of time slots; and FPGA 202 handles slot-accurate emission. Because the FPGA 202 has no dependencies on a specific DMA implementation, it integrates transparently with any compliant engine.

For example, a host server posts a 64 KB buffer via QDMA. The FPGA 202 chops it into 1200-byte chunks, posts 54 requests for grant of time slots, receives corresponding time slot grants spread across Epochs N to N+5, and transmits accordingly, all without intervention by the host server. Descriptor formats that carry destination ID, priority, and optional DSU policy hints may be provided. Scatter-gather and large-page mappings may be supported for efficiency.

### DSU Slot Awareness Per Host

Each host (e.g. host server) may reserve specific time slots and epochs for communication with the DSU to exchange control data. The NIC's slot timer and control plane ensure exchanges of requests for grant of time slots and time slot grants issued by the DSU occur predictably even under heavy payload load. For example, every 10th epoch, a certain time slot (e.g. Slot 0) is reserved for communication with the DSU. Even if the queues used for handling payload data destinated for other nodes are full, the FPGA 202 pauses payload in that slot to ensure reliable exchange of control data.

The embodiments described above demonstrate that methods and network interface modules in accordance with the present disclosure achieve higher bandwidths for data transmission than conventional network interface modules. In particular, the use of buffer tokens in the manner described such a way that enables payload data to be transmitted in a manner that is not restricted to the order in which the payload data is received by the network interface module, which is particularly advantageous in scenarios in which data directed to different network destinations is transmitted in a multiplexed (e.g. TMD) fashion. The benefits of the present disclosure are particularly pertinent in optical networks where fast, high bandwidth data transmission is particularly in demand.

1. A method of preparing data for transmission in a network, the method comprising:
receiving a plurality of data packets from a data source, each data packet comprising payload data to be transmitted over the network and header data comprising data representing a destination to which the payload data is to be delivered;
dividing the payload data of the data packets into a plurality of data chunks, wherein each data chunk is configured to be transmitted over the network in a respective time slot to be assigned to the data chunk;
generating requests for grant of time slots for transmitting the data chunks over the network to network destinations in the network corresponding to the destinations represented in the header data of the data packets;
transmitting the requests for grant of time slots to a data scheduling unit, DSU;
receiving time slot grants from the DSU, the time slot grants defining time slots in which data chunks are permitted to be transmitted to network destinations specified by the time slot grants;
writing the data chunks to a buffer memory;
assigning, to each of the data chunks written to the buffer memory, a respective buffer token and recording a mapping between each buffer token and the memory address of the respective data chunk in the buffer memory;
reading, using the buffer tokens, the data chunks from the buffer memory for transmission over the network in accordance with the received time slot grants.

2. The method of claim 1, wherein the network is an optical network.

3. The method of claim 1, wherein the method further comprises looking up the destinations of the payload data of each of the data packets in a destination table that comprises mappings of the destinations of the payload data of the data packets to network destinations in the network, and tagging each data chunk with a network destination identifier which identifies the network destination mapped in the network destination table to the destination of the payload data of the data packet from which the data chunk was generated;
wherein preferably the data representing the destination of the payload data in each data packet is a network address.

4. The method of claim 3, wherein each of the data chunks is further tagged with a timestamp identifying a time at which the data chunk was generated from said data packet; and
preferably wherein the timestamp comprises an epoch, and a time slot within said epoch, during which the data chunk was generated from the respective data packet.

5. The method of claim 4, wherein, for each data chunk, a respective request for grant of time slots is generated, wherein each request for grant of time slots comprises the network destination identifier and the timestamp with which the data chunk is tagged.

6. The method of claim 5, further comprising storing the generated requests for grant of time slots in a request and grant table.

7. The method of claim 6, wherein each of the received time slot grants comprises data identifying a time interval during which the corresponding request for grant of time slots was generated.

8. The method of claim 7, wherein reading the data chunks from the buffer memory in accordance with the received time slot grants comprises, for each received time slot grant:
looking up, in the request and grant table, a request for grant of time slots comprising the time interval identified by the time slot grant and having the same network destination; and
reading from the buffer memory the data chunk for which said request for grant of time slots was generated.

9. The method of claim 3, wherein each of the data chunks is further tagged with an importance level value, wherein preferably the requests for grant of time slots comprise the importance level values of the data chunks for which time slot grants are being requested.

10. The method of claim 1, further comprising receiving one or more back-pressure signals and, in response to receiving the one or more back-pressure signals, performing one or more control logic functions, wherein preferably the one or more control logic functions comprise one or more of:
limiting a rate at which the payload data of the data packets are data packets are divided into data chunks,
limiting a rate at which the requests for grant of time slots are transmitted to the DSU, and
merging the payload data of at least some of the data packets before dividing those data packets into data chunks.

11. The method of claim 1, further comprising:
monitoring the age of each of the data chunks stored in the buffer memory;
determining that the ages of one or more of the data chunks stored in the buffer memory have exceeded a predetermined threshold age; and
discarding the buffer tokens of those data chunks and/or removing those data chunks from the buffer memory.

12. The method of claim 1, wherein each buffer token comprises data identifying the network destination of the data packet from which the chunk was generated and a timestamp identifying a time at which the data chunk was generated from said data packet.

13. The method of claim 1, wherein assigning each buffer token to its respective data chunk comprises storing the buffer token in a buffer token storage, and wherein the method further comprises removing the buffer token from the buffer token storage after the respective chunk has been read from the buffer memory.

14. The method of claim 1, further comprising:
storing the data chunks read from the buffer memory in one or more transmit buffers that are in communication with one or more transceivers configured to generate signals for transmitting the data chunks over the network; and
transmitting the data chunks from the transmit buffers to the transceivers for transmission over the network by the transceivers;
wherein preferably the network is an optical network and the signals generated by the transceivers are optical signals.

15. The method of claim 14, wherein, for each transmit buffer, the data chunks stored in the transmit buffer are stored in an order corresponding to the temporal order of the time slots in which those data chunks are to be transmitted.

16. The method of claim 14, wherein the transmit buffers are first-in-first-out memories, such that the order in which the data chunks are transmitted from each transmit buffer to the transceivers is the same as the order in which the data chunks stored in that transmit buffer were stored in the transmit buffer.

17. A method of receiving data transmitted over a network, the method comprising:
receiving a plurality of data chunks transmitted over the network;
writing the data chunks to a buffer memory;
assigning, to each of the data chunks written to the buffer memory, a respective buffer token and recording a mapping between each buffer token and the memory address of the respective data chunk in the buffer memory;
reading, using the buffer tokens, the data chunks from the buffer memory; and
assembling the data chunks read from the buffer memory into one or more data packets, each data packet comprising at least one of the data chunks.

18. The method of claim 17, wherein the method further comprises tagging each of the data chunks with a network source identifier which identifies a network source from which the data chunk was received and/or a timestamp identifying a time at which the data chunk was received.

19. The method of claim 18, wherein each buffer token comprises the network source identifier and/or the timestamp with which the respective data chunk was tagged.

20. The method of claim 17, wherein assembling the data chunks into the one or more data packets comprises:
defining, for each data packet, a respective reordering window, the reordering window comprising a sequence position for each data chunk belonging to the data packet;
assigning to each of the data chunks one of the sequence positions in the reordering window of the data packet to which the data chunk belongs; and
wherein reading, using the buffer tokens, the data chunks from the buffer memory comprises, for each of the reordering windows, in response to all the sequence positions of one of the reordering windows having been assigned to a respective data chunk, reading the data chunks of the data packet from the buffer memory; and
wherein the step of assembling the data chunks read from the buffer memory into one or more data packets comprises, for each of the data packets, assembling the data chunks of the data packet into the data packet in response to said data chunks being read from the buffer memory.

21. The method of claim 17, further comprising:
looking up the network source identifier of each of the data packets in a source table that comprises mappings of the network source identifiers to host destinations; and
transmitting each of the data packets to the host destination to which the source identifier of the data packet is mapped in the source table.

22. (canceled)
